(19) United States
(12) Patent Application Publication
(10) Pub. No.: US 2025/0362375 A1
(43) Pub. Date: Nov. 27, 2025

(54) FIRST NODE, SECOND NODE AND METHODS PERFORMED THEREBY FOR HANDLING TRANSMISSION OF A FIRST SIGNAL

(71) Applicant: Telefonaktiebolaget LM Ericsson (publ), Stockholm (SE)

(72) Inventors: Konstantinos VANDIKAS, Solna (SE); Abdulrahman ALABBASI, Kista (SE); Alexandros NIKOU, Danderyd (SE); Hassam RIAZ, Järfälla (SE); Alessandro PREVITI, STOCKHOLM (SE); Klaus RAIZER, INDAIATUBA (BR)

(73) Assignee: Telefonaktiebolaget LM Ericsson (publ), Stockholm (SE)

(21) Appl. No.: 18/867,184

(22) PCT Filed: Aug. 5, 2022
(86) PCT No.: PCT/EP2022/072046

§ 371 Date: Nov. 19, 2024

(30) Foreign Application Priority Data
May 20, 2022 (GR) 20220100418

(51) Int. Cl. G01S 7/00; G01S 13/00; G01S 13/86

(52) U.S. Cl. CPC G01S 7/006; G01S 13/003; G01S 13/86

(57) ABSTRACT

A computer-implemented method performed by a first node (101) for handling transmission of a first signal (151). The first node (111) determines (503) one or more characteristics of the first signal (151) to be transmitted by a radio network node (111) to enable detection of one or more first objects (131) within a distance of one or more second objects (132). This is so that a collision of the one or more first objects (131) with the one or more second objects (132) is estimated. The transmission of the first signal (151) is to detect a reflection (152) of the first signal (151) from the one or more first objects (131) or the one or more second objects (132). The first node (101) then provides (504) an indication of the determined one or more characteristics to the radio network node (111) or to a second node (102) operating in the communications system (100).

### TECHNICAL FIELD

The present disclosure relates generally to a first node and methods performed thereby for handling transmission of a first signal. The present disclosure also relates generally to a second node, and methods performed thereby, for handling transmission of the first signal. The present disclosure further relates generally to computer programs and computer-readable storage mediums, having stored thereon the computer programs to carry out these methods.

### BACKGROUND

Computer systems in a communications network or system may comprise one or more nodes. A node may comprise one or more processors which, together with computer program code may perform different functions and actions, a memory, a receiving port and a sending port. A node may be, for example, a server. Nodes may perform their functions entirely on the cloud.

The communications network may cover a geographical area which may be divided into cell areas, each cell area being served by another type of node, a network node in the Radio Access Network (RAN), radio network node or Transmission Point (TP), for example, an access node such as a Base Station (BS), e.g., a Radio Base Station (RBS), which sometimes may be referred to as e.g., Fifth Generation (5G) Node B (gNB), evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood as the geographical area where radio coverage is provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

User Equipments (UEs) within the communications network may be e.g., wireless devices, stations (STAs), mobile terminals, wireless terminals, terminals, and/or Mobile Stations (MS). UEs may be understood to be enabled to communicate wirelessly in a cellular communications network or wireless communication network, sometimes also referred to as a cellular radio system, cellular system, or cellular network. The communication may be performed e.g., between two UEs, between a wireless device and a regular telephone and/or between a wireless device and a server via a Radio Access Network (RAN) and possibly one or more core networks, comprised within the wireless communications network. UEs may further be referred to as mobile telephones, cellular telephones, laptops, or tablets with wireless capability, just to mention some further examples. The UEs in the present context may be, for example, portable, pocket-storable, hand-held, computer-comprised, or vehicle-mounted mobile devices, enabled to communicate voice and/or data, via the RAN, with another entity, such as another terminal or a server.

In 3rd Generation Partnership Project (3GPP) Long Term Evolution (LTE), base stations, which may be referred to as gNBs. eNodeBs or even eNBs, may be directly connected to one or more core networks.

Nodes in a core network may use machine learning (ML) techniques to analyze data in the communications network.

To enable co-existence between humans and robots in Industry 4.0 environments, computer vision-based solutions have been developed that may determine proximity between humans and robots and, consequently, either produce warnings to humans when they may be potentially in danger, stop the operation of the robot, and generally change the movement of the robot or parts thereof to avoid any potential collision. The need for such techniques is motivated in such environments since to fulfil the need for smart manufacturing, such environments may need to change their layout to fulfill different manufacturing requirements. As such, typical solutions for protecting humans such as having fixed safety zones or even placing robots in cages are not feasible. Even though computer vision techniques may be very effective, they may come with an additional cost since they may require the installation of cameras, the use of costly machine learning models, the need of datasets to train accordingly, and the installation of additional sensors in the environment to further measure proximity, thus compensating for any drawbacks of the probabilistic nature of the machine learning model.

Joint communication and sensing (JCAS) may be understood to be a technique similar to that of radar, which may be used to identify the location of different objects, and which may leverage using one, in monostatic operation, or multiple antennas in a telecommunication network. Its main advantage may be understood to be that it may be applied to existing installations without the need for additional hardware. As such, it may be understood to be a suitable alternative for this problem.

The main idea behind JCAS may be understood to be to allocate a sensing slot where a first base station, e.g., gNB1, may send a sensing signal, and a second base station, e.g., gNB2, may observe such reflected signal, both the line of sight and the reflected signal from the object to be sensed. There may be understood to be several techniques to calculate the distance to the sensed object, such as Angle of Arrival (AoA), Electronic Distance Measuring Instrument (EDMI), and Delay-Spread or Time-Difference, which will be briefly described next.

### AoA

Two ways of using AOA to estimate location are shown in the schematic diagram of FIG. 1. In FIG. 1, the location of a car 10 is determined with one reference terminal 11 in panel (A), and with two refence terminals 11, 12 in panel (B). FIG. 1 (A) combines AoA with a distance measuring method, Received Signal Strength (RSS) or Time of Arrival (TOA), to estimate location using only one reference terminal 11. In FIG. 1 (B), the direction lines of the directional antennas of the two terminals 11, 12 cross at the target location of the car 10. Target coordinates x and y may be found, according to the equations depicted in the figure, from the known fixed terminal coordinates F1 (0,0) for the first terminal 11 and F2 (x2, x2) for the second terminal 12, and the antenna beam angles θ in (A), and θ₁ and θ₂ in (B), in relation to a common reference direction.

### EDMI

The principle of EDMI, where a pulse or continuous wave of radio frequency (RF) may be fired from a transmitter and the reflected energy may be captured is illustrated in the schematic diagram of FIG. 2. Using the time of travel (TOT) of this RF, the distance between the transmitter and reflector may be determined. The reflector may be a natural object or an artificial reflector, such as a prism. In some systems, this distance may be understood to be one of the primary measurements which, with integration with other measurements, such as signal strength, AoA, harmony disruption, etc. . . . , may also provide the coordinates of the reflector.

### Delay-Spread or Time-Difference

FIG. 3 is a schematic diagram illustrating the principle of delay-spread or time-difference that may be used to calculate the distance between two target positions 30, using in this case, two different reference terminals, a first reference terminal 31 to transmit pulses, and a second reference terminal 32 to receive the echoes of the transmitted pulses. As illustrated in in FIG. 3, the time Δt between received pulse echoes may give the distance R between the target positions. Here, ‘c’ is the speed of light. A similar concept may apply to the difference between power and delay, that is, the Delay-Spread.

Existing methods to determine the proximity between several objects, such as between humans and robots, however, may lead to misuse of resources in a communications system and impoverish its performance.

### SUMMARY

As part of the development of embodiments herein, one or more challenges with the existing technology will first be identified and discussed.

The main issue with any JCAS technique is that while sensing, communication may be disrupted for a short period. Therefore, JCAS may be understood to come at the expense of the current utilisation of spectrum, which may be typically reserved for transferring data, and not for detecting physical objects. Therefore, JCAS may need to be exercised intelligently. In addition, one may be understood to need to determine the frequency of the sensing slot, the spread across the frequency domain and the antenna dimension, and in the case of bi/multi-static antennas, the coordination between them to enable this process.

According to a first aspect of embodiments herein, the object is achieved by a computer-implemented method, performed by a first node. The method is for handling transmission of a first signal. The first node operates in a communications system. The first node determines one or more characteristics of the first signal to be transmitted by a radio network node. The transmission of the first signal is to enable detection of one or more first objects within a distance of one or more second objects so that a collision of the one or more first objects with the one or more second objects is estimated. The transmission of the first signal by the radio network node is to detect a reflection of the first signal from the one or more first objects or the one or more second objects. The first node then provides an indication of the determined one or more characteristics to the radio network node, or to a second node operating in the communications system.

According to a second aspect of embodiments herein, the object is achieved by a computer-implemented method, performed by the second node. The method is for handling transmission of the first signal. The second node operates in the communications system. The second node determines a function, using machine learning. The function enables to determine the one or more characteristics of the first signal to be transmitted by the radio network node to enable detection of the one or more first objects within the distance of the one or more second objects so that the collision of the one or more first objects with the one or more second objects is estimated. The transmission of the first signal by the radio network node is to detect the reflection of the first signal from the one or more first objects or the one or more second objects. The second node then provides a first indication of the determined function to the first node operating in the communications system.

According to a third aspect of embodiments herein, the object is achieved by the first node, for handling transmission of the first signal. The first node is configured to operate in the communications system. The first node is further configured to determine the one or more characteristics of the first signal. The first signal is to be transmitted by the radio network node to enable the detection of the one or more first objects within the distance of the one or more second objects. The detection is so that the collision of the one or more first objects with the one or more second objects is estimated. The transmission of the first signal by the radio network node is configured to be to detect the reflection of the first signal from the one or more first objects or the one or more second objects. The first node is also configured to provide the indication of the one or more characteristics configured to be determined, to the radio network node or to the second node configured to operate in the communications system.

According to a fourth aspect of embodiments herein, the object is achieved by the second node, for handling transmission of the first signal. The second node is configured to operate in the communications system. The second node is further configured to determine the function using machine learning. The function is configured to enable to determine the one or more characteristics of the first signal configured to be transmitted by the radio network node to enable the detection of the one or more first objects within the distance of the one or more second objects. The detection is so that the collision of the one or more first objects with the one or more second objects is estimated. The transmission of the first signal by the radio network node is to detect the reflection of the first signal from the one or more first objects or the one or more second objects. The second node is also configured to provide the first indication of the function configured to be determined to the first node configured to operate in the communications system According to a fifth aspect of embodiments herein, the object is achieved by a computer program, comprising instructions which, when executed on at least one processor, cause the at least one processor to carry out the method performed by the first node.

According to a sixth aspect of embodiments herein, the object is achieved by a computer-readable storage medium, having stored thereon the computer program, comprising instructions which, when executed on at least one processor, cause the at least one processor to carry out the method performed by the first node.

According to a seventh aspect of embodiments herein, the object is achieved by a computer program, comprising instructions which, when executed on at least one processor, cause the at least one processor to carry out the method performed by the second node.

According to an eighth aspect of embodiments herein, the object is achieved by a computer-readable storage medium, having stored thereon the computer program, comprising instructions which, when executed on at least one processor, cause the at least one processor to carry out the method performed by the second node.

By determining the one or more characteristics of the first signal to be transmitted by the radio network node, the first node may enable to improve utilization of communication and sensing in the communications system since “muting” or halting of the communication in favor of sensing may take place only at critical times, thus enabling for maximum communication. Furthermore, the first node may enable energy savings on the side of the radio network node and any devices performing communication through the radio network node, since communication may be understood to not be halted naively, which may be understood to require retransmissions, but instead done diligently when there may be a need for it. Moreover, the first node may enable to increase physical security, by enabling to avoid that the one or more first objects collide with the one or more second objects, without the need for additional hardware.

By the first node providing the second indication to the radio network node, the first node may enable to estimate the collision of the one or more first objects with the one or more second objects without “muting” or halting of the communication naively. By the first node providing the second indication to the second node, the first node may enable the second node to update the function and increase the level of accuracy.

By the second node obtaining the function, and then providing the first indication indicating the function to the first node, the second node may enable the first node to use the function to determine the one or more characteristics of the first signal to be transmitted by the radio network node to enable detection of the one or more first objects within the distance of the one or more second objects, so that the collision of the one or more first objects with the one or more second objects may be estimated without “muting” or halting of the communication naively, thereby enabling the advantages described earlier.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of using AOA to find location with (A) rho-theta, (B) theta-theta, or triangulation, according to existing methods.

FIG. 2 is a schematic diagram illustrating a non-limiting example of the principle of range measurement using radio frequency, according to existing methods.

FIG. 3 is a schematic diagram illustrating a non-limiting example of the time-difference operation in a joint communication and sensing, bi/multi-static setup, according to existing methods.

FIG. 4 is a schematic diagram illustrating two non-limiting examples, in panel a) and panel b), respectively, of a communications system, according to embodiments herein.

FIG. 5 is a flowchart depicting embodiments of a method in a first node, according to embodiments herein.

FIG. 6 is a flowchart depicting embodiments of a method in a second node, according to embodiments herein.

FIG. 7 is a schematic diagram depicting a monostatic setup with one gNB with 2 cells, or 2 antennas, according to embodiments herein.

FIG. 8 is a schematic diagram depicting a multi-static setup with two gNBs and receivers on the robotic arms, according to embodiments herein.

FIG. 9 is a schematic diagram depicting a packet scheduler, according to embodiments herein.

FIG. 10 is a schematic diagram depicting Tx-to-Rx cancellation, according to embodiments herein.

FIG. 11 is a schematic diagram depicting a potential placement of a JSAC controller in an automation architecture, according to a non-limiting example of embodiments herein.

FIG. 12 is a schematic diagram depicting a non-limiting example of a method in a first node and in second node, according to embodiments herein.

FIG. 13 is a schematic diagram depicting aspects of a method in a first node, according to embodiments herein.

FIG. 14 is a schematic diagram depicting another non-limiting example of a method in a first node and in a second node, according to embodiments herein.

FIG. 15 is a schematic block diagram illustrating two non-limiting examples, a) and b), of a first node, according to embodiments herein.

FIG. 16 is a schematic block diagram illustrating two non-limiting examples, a) and b), of a second node, according to embodiments herein.

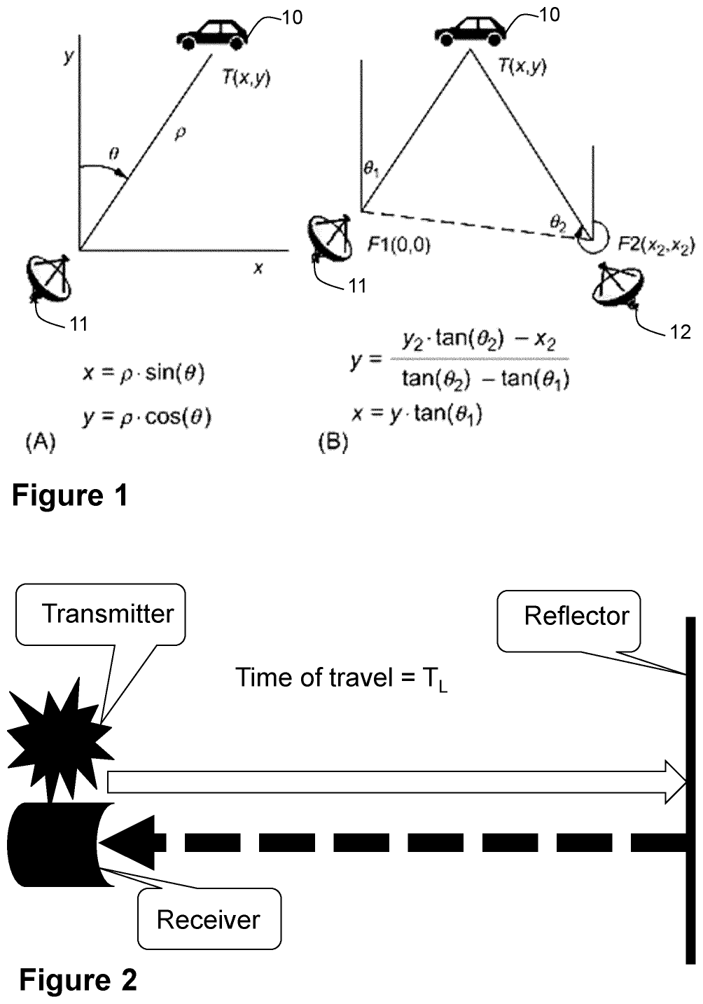

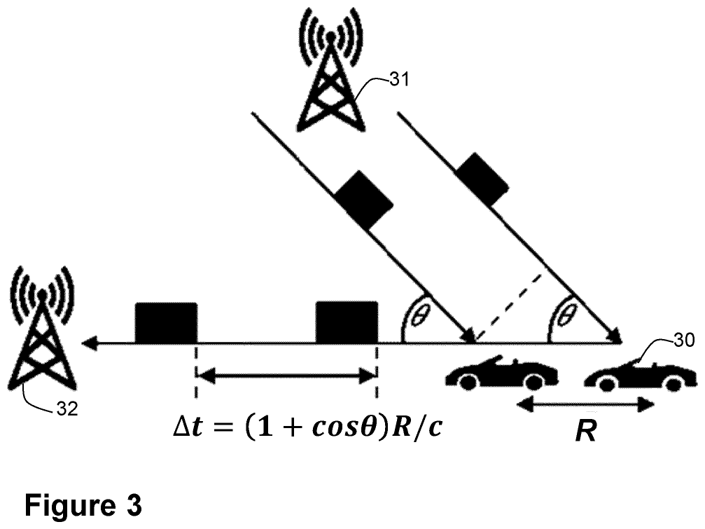

### DETAILED DESCRIPTION

Certain aspects of the present disclosure and their embodiments address the challenges identified in the Background and Summary sections with the existing methods and provide solutions to the challenges discussed.

Embodiments herein may be understood to overcome the challenges of the existing methods by providing a method to optimize joint communication sensing in human/robot collaborative environments.

To improve on the problem highlighted in the summary section, embodiments herein may be understood to introduce a mechanism that may aim at identifying when it may be important to do such sensing, that is, in critical circumstances, thus allowing for maximizing the utilization of spectrum to transfer traffic between the UEs as much as possible.

As a summarized overview, embodiments herein may be understood to introduce a single agent and Multi-Agent RL approach for solving the problem of when to sense and when to transmit data. The single agent RL approach may apply in the case where a single antenna may be used, while the multi-agent RL approach may apply in the case where multiple antennas may be used and, as such, the different nodes that may be involved may need to negotiate when they may transmit sensing signals.

The main goal of embodiments herein may be understood to be to provide a mechanism which may enable to determine when such sensing signal may need to be sent, and what may be the optimal characteristics of such sensing signal, to avoid a human or an object from being harmed and, at the same time, minimize any potential communication network footprint impact. Consequently, once it may be detected that a human may be potentially harmed while in the vicinity of a robot, another signal may be broadcasted to affect the behavior of the robot.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

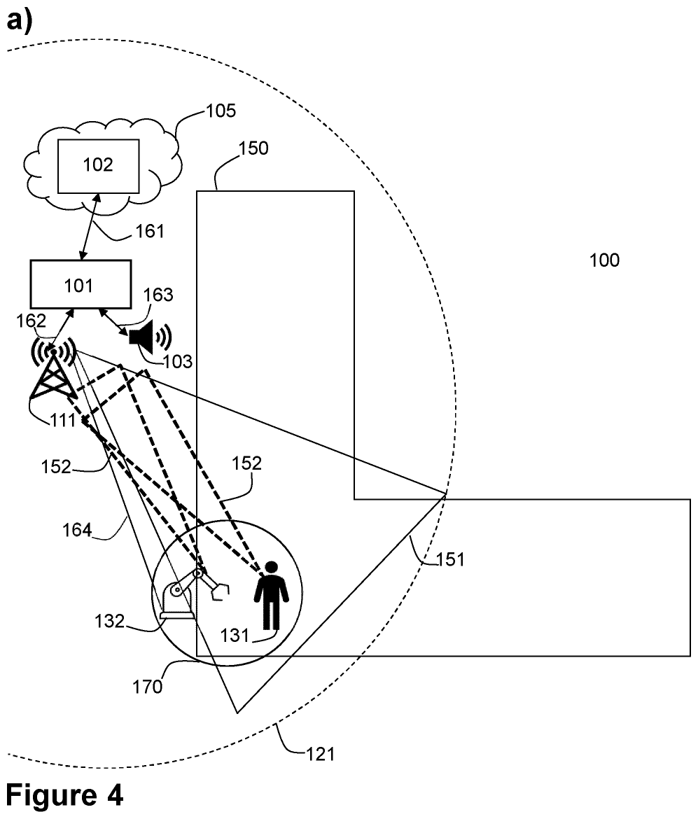

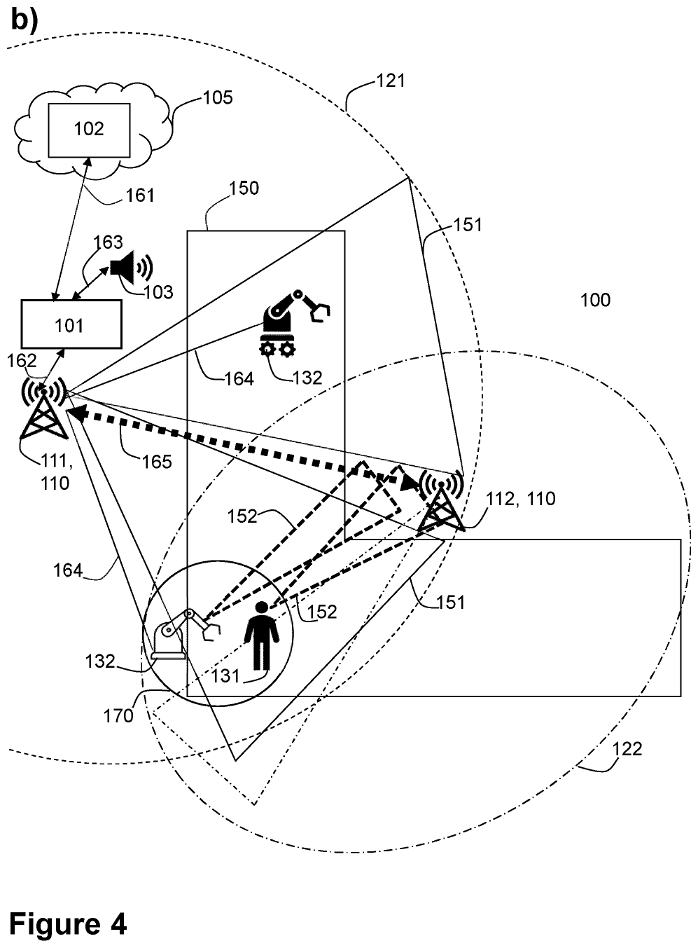

FIG. 4 depicts two non-limiting examples, in panels “a” and “b”, respectively, of a communications system 100, in which embodiments herein may be implemented. The communications system 100 may be understood as a telecommunications system, sometimes also referred to as a telecommunications network, cellular radio system, cellular network or wireless communications system. In some examples, the communications system 100 may for example be a network such as a 5G system, e.g., 5G Core Network (CN), 5G New Radio (NR), an Internet of Things (IoT) network, a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, or a newer system supporting similar functionality. The communications system 100 may also support other technologies, such as, e.g., Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The communications system 100 may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 comprises a first node 101 and a second node 102, which are depicted in FIG. 4. In some embodiments, the communications system 100 may comprise a another node 103. It may be understood that the communications system 100 may comprise more nodes than those represented in FIG. 4. Any of the first node 101, the second node 102 and the another node 103 may be, respectively, a first computer system, a second computer system and a third computer system. In some examples, any of the first node 101, the second node 102 and the another node 103 may be implemented as a standalone server in e.g., a host computer in the cloud 105, as depicted in the non-limiting example depicted in the non-limiting examples of FIG. 4 for the second node 102. Any of the first node 101, the second node 102 and the another node 103 may, in some examples, be a distributed node or distributed server, with some of their respective functions being implemented locally, e.g., by a client manager, and some of its functions implemented in the cloud 105, by e.g., a server manager. Yet in other examples, any of the first node 101, the second node 102 and the another node 103, may also be implemented as processing resources in a server farm.

In some embodiments, the first node 101, the second node 102 and the another node 103 may be independent and separated nodes, as depicted in the non-limiting examples of FIG. 4. In other embodiments, the first node 101, the second node 102 and the another node 103 may co-localized or be the same node. All the possible combinations are not depicted in FIG. 4 to simplify the Figure.

The second node 102 may be understood as a node having a capability to perform machine-learning, e.g., Deep Q-Network (DQN). The first node 101 may be understood as a node having a capability to implement a machine-learning model, such as a DQN machine-learning model. In typical examples, the another node 103 may be a device, e.g., an IoT device, capable of producing sound and/or a light signal, e.g., as an alarm.

In some non-limiting examples, the communications system 100 may comprise one or more radio network nodes, whereof a radio network node 111 is depicted in panel a) and panel b) of FIG. 4. In some embodiments, such as the non-limiting example depicted in panel b) of FIG. 4, the radio network node 111 may be a first radio network node 111 of a plurality of radio network nodes 110, which may be comprised in the communications system 100.

The a plurality of radio network nodes 110 may comprise, in addition to the first radio network node 111, other radio network nodes 112, which may be understood to be one or more second radio network nodes 112. Any of the first radio network node 111 and the other radio network nodes 112 may typically be a base station or Transmission Point (TP), or any other network unit capable to serve a wireless device or a machine type node in the communications system 100. Any of the first radio network node 111 and the other radio network nodes 112 may be e.g., a 5G gNB, a 4G eNB, or a radio network node in an alternative 5G radio access technology, e.g., fixed or WiFi. Any of the first radio network node 111 and the other radio network nodes 112 may be e.g., a Wide Area Base Station, Medium Range Base Station, Local Area Base Station and Home Base Station, based on transmission power and thereby also coverage size. Any of the first radio network node 111 and the other radio network nodes 112 may be a stationary relay node or a mobile relay node. Any of the first radio network node 111 and the other radio network nodes 112 may support one or several communication technologies, and its name may depend on the technology and terminology used. Any of the first radio network node 111 and the other radio network nodes 112 may be directly connected to one or more networks and/or one or more core networks.

The communications system 100 may cover a geographical area, which in some embodiments may be divided into cell areas, wherein each cell area may be served by a radio network node, although, one radio network node may serve one or several cells. The first radio network node 111 serves one or more first cells 121, which are partially depicted in the non-limiting examples of FIG. 4 with a dashed circular shape. Each of the other radio network nodes 112 in the plurality of radio network nodes 110 serve, respectively, one or more second cells 122, which are partially depicted in the non-limiting example of panel b) in FIG. 4 with a dashed oval shape.

Any of the first radio network node 111 and the other radio network nodes 112 may be of different classes, such as, e.g., macro eNodeB, home eNodeB or pico base station, based on transmission power and thereby also cell size. In some examples, any of the first radio network node 111 and the other radio network nodes 112 may serve receiving nodes with serving beams. The radio network node may support one or several communication technologies, and its name may depend on the technology and terminology used. Any of the radio network nodes that may be comprised in the communications system 100 may be directly connected to one or more core networks.

The communications system 100 may comprise one or more first objects 131 and the one or more second objects 132. In some examples, any of the one or more first objects 131 and the one or more second objects 132 may be also known as e.g., user equipment (UE), a wireless device, mobile terminal, wireless terminal and/or mobile station, device with wireless capability, a Customer Premises Equipment (CPE), an Internet of Things (IoT) device, a Machine-to-Machine (M2M) device, a robot, a device equipped with a wireless interface, just to mention some further examples. Any of the one or more first objects 131 and the one or more second objects 132 in the present context may be, for example, a vehicle-mounted mobile device, enabled to communicate voice and/or data, via a RAN, with another entity, such as a server, a laptop, a Personal Digital Assistant (PDA), or a tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. Any of the one or more first objects 131 and the one or more second objects 132 may be wireless, i.e., it may be enabled to communicate wirelessly in the communications system 100. The communication may be performed e.g., between two devices, between a device and a radio network node, such as the first radio network node 111, and/or between a device and a server. The communication may be performed e.g., via a RAN and possibly one or more core networks, comprised, respectively, within the communications system 100.

In some examples, such as those depicted in FIG. 4, any of the one or more first objects 131 may be a human. In panel a), the one or more second objects 132 are depicted as a static robot, in white, with a motorized arm. In panel b), the one or more second objects 132 are depicted as comprising the static robot and a mobile robot, depicted in solid black, with a motorized arm.

The one or more first objects 131 and the one or more second objects 132 may be located in a space 150, such as a hallway, a room, a hangar, etc., The space 150 is represented in FIG. 4 as an L shaped hallway.

The first radio network node 111 may transmit a first signal 151, depicted as a triangle with solid lines in FIG. 4. Transmission of the first signal 151 may result in reception of a reflection 152, depicted as a triangle with dashed lines in FIG. 4, from the one or more first objects 131 or the one or more second objects 132. In the example of panel a), the reflection 152 is received by the first radio network node 111, whereas in the example of panel b), the reflection 152 is received by the other radio network node 112. It may be understood that while the reflection 152 is expressed in singular from, the reflection 152 may comprise a respective reflection, that is, a dashed triangle, from any of the one or more first objects 131 and the one or more second objects 132. It may be noted that the respective reflection from the motorized second object 132 in panel b) of FIG. 4 is not depicted to simplify the figure.

The first node 101 may communicate with the second node 102 over a first link 161, e.g., a radio link or a wired link. The first node 101 may communicate with the radio network node 111 over a second link 162, e.g., a radio link or a wired link. The first node 101 may communicate with the third node 103 over a third link 163, e.g., a radio link or a wired link. The radio network node 111 may communicate, directly or indirectly, with any of the one or more second objects 132 over a respective fourth link 164, e.g., a radio link or a wired link. The radio network node 111 may communicate, directly or indirectly, with each of the other radio network nodes 112 over a respective fifth link 165, e.g., a radio link or a wired link. The radio network node 111 may communicate, directly or indirectly, with any of the one or more first objects 131, in the event these are machines, and not humans, over a respective sixth link, e.g., a radio link or a wired link, which is not depicted in FIG. 4, where the first object 131 represented is a human. Any of the first link 151, the second link 152, the third link 153, the respective fourth link 154, the respective fifth link 165 and/or the respective sixth link may be a direct link or it may go via one or more computer systems. Any of the first link 151, the second link 152 and/or the third link 153 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 4.

Also depicted in FIG. 4 is a first space 170, which may also be referred to herein as a “critical area”, which may be understood as a virtual space surrounding an equipment that may potentially harm a human when the human may be in that vicinity.

In general, the usage of “first”, “second”, “third”, “fourth”, “fifth”, “sixth” and/or “seventh” herein may be understood to be an arbitrary way to denote different elements or entities, and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

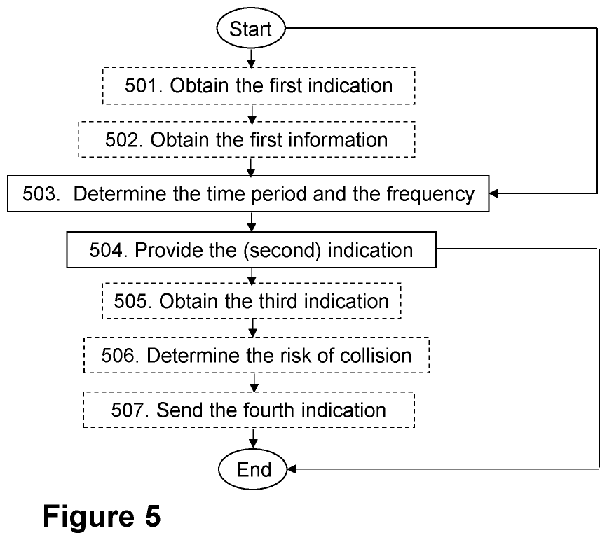

Embodiments of a computer-implemented method, performed by the first node 101, will now be described with reference to the flowchart depicted in FIG. 5. The method may be understood to be for handling transmission of the first signal 151. The first node 101 operates in the communications system 100. The first node 101 may be, for example, a JCAS controller node, which may be understood to manage a logical function, which may be comprised, is some non-limiting examples, within the radio network node 111.

The method may comprise the actions described below. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first node 101 is depicted in FIG. 5. In FIG. 5, optional actions in some embodiments may be represented with dashed lines.

### Action 501

In this Action 501, the first node 101 may obtain a first indication from one of a memory and the second node 102. Obtaining may be understood as retrieving from the memory, receiving from the second node, e.g., via the first link 161, or similar.

The first indication may indicate a function determined by the second node 102 using machine learning. The function may be understood to be a mathematical function. The function may enable to determine one or more characteristics of the first signal 151 to be transmitted by the radio network node 111 to enable detection of the one or more first objects 131 within a distance of the one or more second objects 132 so that a collision of the one or more first objects 131 with the one or more second objects 132 may be estimated. The collision may be understood to be estimated in the next n timesteps.

The estimation of the distance may then enable estimate a probability of collision between the one or more first objects 131 and the one or more second objects 132, and thereby enable to avoid the collision.

The transmission of the first signal 151 by the radio network node 111 may be understood to be to detect the reflection 152 of the first signal 151 from the one or more first objects 131 or the one or more second objects 132.

The first signal 151 may be also known as pulse. The reflection 152, that is, the echoes that may be received back from the first signal 151 may then be processed to produce the distance between the one or more first objects 131 and the one or more second objects 132 by measuring a time difference. The reflection 152, as explained earlier, may have been detected by the radio network node 111 itself, as depicted in the non-limiting example of panel a) of FIG. 4, or by the other radio network nodes 112 and then indicated back to the radio network node 111, e.g., via the respective fifth link 165, as depicted in the non-limiting example of panel b) of FIG. 4. Based on that and by performing different scans, the first node 101 may then measure distance over time or speed for a moving object.

The radio network node 111 may transmit the first signal 151 with one or more antennas enabled to perform communication and sensing. The first node 101 may, in some examples, control one or more antennas from the radio network node 111, or it may control antennas of the radio network node 111 and a regular radar device collocated with the radio network node 111 where, in that setup, the radio network node 111 may handle communication while the radar may handle the process of scanning for nearby objects.

The first signal 151 may produce a Tx-to-Rx cancellation block that may disrupt communication for a short period of time which may be used to detect the presence of different objects, such as the one or more first objects 131 and the one or more second objects 132. The first signal 151, a scanning pulse, may be understood to be meant to occur at the beginning of a Tx-to-Rx cancellation slot. A slot may be understood as a set of time-frequency resources, e.g., a set of symbols spanning a number of carriers. A number of slots may be pre-configured, such as Slot 0, Slot 1, Slot 2, etc., In the case of very close proximity between a human and robot, the Tx-to-Rx cancellation may puncture an existing transmission so that it may be ensured that the first signal 151 may be delivered immediately, and may scan for proximity as soon as possible to produce a warning. Even though the Tx-to-Rx cancellation block may cause a disruption in communication, using Hybrid automatic repeat request (HARQ), it may be possible to set up the first signal 151 or pulse in such a way which may allow for the re-transmission of the missing information. This may in turn enable any wireless devices, e.g., UEs, which may be in the space 150 wherein the transmission of the first signal 151 may be to be produced, to resume their communication while this scanning takes place.

The one or more characteristics may comprise: i) a time period during which, and ii) a frequency at which, a transmission to reception cancellation may be to be transmitted by the radio network node 111 to enable the detection of the one or more first objects 131 within the distance of the one or more second objects 132. The frequency may be understood as a radio frequency.

In some embodiments, at least one of the following options may apply. According to a first option, at least one of: a) the one or more first objects 131 and b) the one or more second objects 132 may be mobile. According to a second option, the one or more first objects 131 may consume broadband traffic and the one or more second objects 132 may consume machine-type of communication traffic. The broadband traffic may be, e.g., mobile broadband (eMBB), which may be understood to be typically reserved for humans watching videos/making phone calls, etc. consuming internet traffic. The machine-type communication traffic may be, e.g., Ultra-low latency communication (URLLC) and/or massive machine type communication (mMTC). According to a third option, the one or more first objects 131 may be human and the one or more second objects 132 may be robots.

URLLC traffic may be understood to be typically reserved to send critical, latency-wise, signals to and/or from robotic devices which may be either remote controlled or may need to exchange some information with other robotic devices in a collaborative setting. According to examples of embodiments herein, URLLC traffic may puncture eMBB traffic, which may be typically reserved for regular UEs such as the ones which may be carried by human workers within a factory setting. Even though a UE may have mixed URLLC and eMBB traffic, an object, e.g., a device that may rely heavily on URLLC signal may be understood to be a robot device that may potentially harm a human. A UE that may rely heavily on eMBB traffic may be understood to be a human.

### The Function

The function may enable to determine the one or more characteristics, based on first information input to the function. The first information may indicate a presence of the one or more first objects 131 and the one or more second objects 132 in the space 150 wherein the transmission of the first signal 151 may have to be produced.

More particularly, the function may be a Deep Q Learning (DQN) function Q, which may yield the one or more characteristics as an action (a), given the first information, which may be understood to be a state(s). The function may therefore be Q(s,a).

### a) State Space

The state space for this problem may comprise information about: critical static objects or critical non-moving objects (CNMO), non-critical static objects or non-critical non-moving objects (NCNO), critical moving objects (CMO), non-critical moving objects (NCMO) and estimated speed of moving objects.

The critical static objects may be understood as objects with the machine-type communication traffic, e.g., URLLC traffic, whose position may not change between two or more first signals 151, that is, scanning pulses. As stated earlier, a scanning pulse may be understood to be meant to occur at the beginning of Tx-to-Rx cancellation slot. These objects may be labelled as critical since they may hurt a non-critical object such as a human.

The non-critical static objects may be understood as objects whose position may not change between two or more first signals 151, that is, scanning pulses. These objects may be labelled as non-critical since they may consume/produce predominantly broadband traffic, e.g., eMBB traffic, which may be understood to be typically reserved for humans watching videos/making phone calls consuming internet traffic.

The critical moving objects may be understood as objects whose position may change between two or more scanning pulses and consume/produce URLL traffic

The non-critical Moving objects may be understood as: objects whose position changes between two or more first signals 151, that is, scanning pulses and consume broadband traffic, e.g., eMBB traffic.

The estimated speed of moving objects may be understood as the reflection, that is, the echoes that may be received back from the first signal 151, and which may be processed to produce the distance for different objects by measuring the time difference. Based on that and by performing different scans, the distance over time or speed for a moving object may be measured.

### b) Action Space

One example of the action space for this problem is illustrated bellow. There may be three components to consider in this compound action, the first one may be the selection of the slot. The second may be the selection of the frequency (f). Finally, the third may be whether scheduling of the Tx-to-Rx cancellation slot may need to puncture traffic pre-emptively or not. Preemption may be understood to mean to put information that would otherwise reside in e.g., a minislot, that is, a series of bits meant to be transmitted, into memory, and instead enforce a communication gap which may be understood to be a Tx-to-Rx cancellation. Within that gap the first signal 151, the sensing signal, may be placed. Afterwards, via HARQ, what was supposed to be transmitted in the first place may be retransmitted.

As an example, there may be three slots: Slot 0, Slot 1 and Slot 2, three frequencies: f0, f1 and f2, and whether the scheduling may puncture traffic or not, 0 indicating yes, and 1 indicating no. In spite of this seemingly small set of choices, the action space in this illustrative example contains 19 actions:
(No action—skip time slot)
(Mini Slot 0, f0, 0)
(Min Slot 0, f0, 1)
(Mini Slot 0, f1, 0)
(Mini Slot 0, f1, 1)
(Mini Slot 0, f2, 0)
(Mini Slot 0, f2, 1)
(Mini Slot 1, f0, 0)
(Min Slot 1, f0, 1)
(Mini Slot 1, f1, 0)
(Mini Slot 1, f1, 1)
(Mini Slot 1, f2, 0)
(Mini Slot 1, f2, 1)
(Mini Slot 2, f0, 0)
(Min Slot 2, f0, 1)
(Mini Slot 2, f1, 0)
(Mini Slot 2, f1, 1)
(Mini Slot 2, f2, 0)
(Mini Slot 2, f2, 1)

Despite the large list of actions, it may be possible to efficiently leverage that in the exploration space by representing these different choices via a Monte-Carlo Tree Search (MCTS) [1], where at each step, the set of choices may be no more than 3, or in other words, at each step, a maximum of 3 choices may need to be considered. Without using a data structure, the cost may be understood to be number of mini slots*number of frequencies*preemption while with the use of a data structure such MCTS, the cost may be understood to become mini slots+number of frequencies+preemption. A mini slot may be understood as a slot that may carry only a small number of symbols, e.g., 2 or 4.

As stated earlier, the action space may be further increased to include the selection of the angle of the beam, e.g., among 0, 30, 60 and 90 degrees.

While the details of how the function may have been trained will be explained later, in regard to the actions performed by the second node 102, it may be helpful to explain here that the function may have been trained using a reward function, as follows.

### c) Reward Function

The function may have been trained by the second node 102 by rewarding the system when a collision may be likely to take place in the next n timesteps, and the transmission of the first signal 151 with the one or more characteristics, that is, the scanning pulse/communication disruption, may have been able to detect that, or when no collision is to take place, and there may have been no transmission of the first signal 151, that is, scanning pulse. On the negative side, the reward function may be negative when no collision is to take place and a transmission of the first signal 151, that is, a scanning pulse/disruption of communication, may have taken place, or when a collision has taken place and no scanning pulse/disruption of communication may have taken place.

$$reward = \{ \begin{matrix}positiveReward if ( ( collision ( t + n ) AND scanning ( t - n ) ) OR ( ∼ collision ( t + n ) AND ∼ scanning ( t - n ) ) \\ negativeReward if ( ( \sim collision ( t + n ) AND scanning ( t - n ) ) OR ( collision ( t + n ) AND ∼ scanning ( t - n ) )\end{matrix}$$

By obtaining the first indication in this Action 501, the first node 101 may then be enabled to use the function to determine the one or more characteristics of the first signal 151 to be transmitted by the radio network node 111 to enable detection of the one or more first objects 131 within the distance of the one or more second objects 132, as will be explained in Action 503.

### Action 502

In this Action 502, the first node 101 may obtain the first information to be input to the function. The first node 101 may obtain the first information from the radio network node 111, e.g., a gNB. The radio network node 111 may have transmitted (Tx) the first signal 151, and over (Rx) the radio network node 111 may have received echoes which may be processed to produce a state of the surrounding environment including location of objects and potential collisions based on their previous movement. The first information obtained in this Action 502 may be understood to be this state. Since radio equipment may be understood to be usually preconfigured to operate in certain frequencies, initially, the radio network node 111 may pick one of these, e.g., randomly. The same may be understood to apply for time, which may be e.g., governed by Orthogonal Frequency Division Multiplexing (OFDM).

Obtaining may be understood as receiving, e.g., via the second link 162.

Embodiments herein may comprise two variations, corresponding to setups corresponding to that are shown in panel a) of FIG. 4 and panel b) of FIG. 4. As described earlier, in panel a) of FIG. 4, a static setup is considered, which may be understood to not require coordination between different radio network nodes. Instead, the first network node 111 may broadcast the first signal 151, which may then produce a Tx-to-Rx cancellation block that may disrupt communication for a short period of time which may be used to detect the presence of different objects. In embodiments wherein the communications system 100 may comprise the plurality of radio network nodes 110, e.g., multiple gNBs, such as in the second setup depicted in panel b) of FIG. 4, more antennas may be utilized for the same task. In such embodiments, there may be understood to be an additional challenge, which may be understood to be to make sure that neighboring cells covering the space 150 served by any of the radio network nodes in the plurality of radio network nodes 110, which cells may share the same bearing, that is, that may be facing the same direction, and may be scanning for objects in the same frequency, may not send a respective first signal 151, that is, a respective pulse, the initial part of a Tx-to-Rx cancellation block, when another radio network nodes may be doing so. This may be understood to be since, in that case, it may be possible that they may misinterpret that pulse as an echo, which may yield incorrect results. Sensing between cells having overlapping coverage may be performed in different channels. One other aspect to consider may be understood to be the number of critical objects, moving or not, and the number of moving noncritical objects, as cells that may have a high number of both may probably need to scan for potential collisions more often than others. Therefore, the different antennas may need to coordinate on how they may perform this scanning to avoid interfering with one another. To enable orchestration and synchronization between neighboring cells of the one or more first cells 121 and the one or more second cells 122, a round of leader election may be performed between neighboring cells to determine the cell that may have the most critical, moving or not, objects. This step, e.g., a broadcast message, may only need to be performed once, at a cold-start case, where the cells may have no information about each other. From that step on, this information may be updated with the use of, e.g., a Mobility Management Entity (MME) or an Access and Mobility Management Function (AMF), since when one of the one or more first objects 131 and the one or more second objects 132 may be handed over from one cell to the other, the source cell may know then that the object may not be lingering, and that the target cell may have one more such object.

Hence, in some examples, the obtaining of the first information may be performed after the first network node 111 may receive an additional indication indicating that it may be clear to transmit the first signal 151, either because the first network node 111 may have been elected the leader, or because the leader may have concluded its transmission-to-reception cancellation window, and it may be the turn of the first network node 111 to perform the scanning. In other words, the non-leading cells may have to wait for the leader to finish its scan before they may scan.

By obtaining the first information in this Action 502, the first node 101 may then be enabled to determine the one or more characteristics of the first signal 151 to be transmitted by the radio network node 111 to enable detection of the one or more first objects 131 within the distance of the one or more second objects 132, as will be explained in the next Action 503, since the first information may be used as input into the function.

### Action 503

In this Action 503, the first node 101 determines the one or more characteristics of the first signal 151 to be transmitted by the radio network node 111 to enable detection of the one or more first objects 131 within the distance of the one or more second objects 132 so that the collision of the one or more first objects 131 with the one or more second objects 132 may be estimated. The transmission of the first signal 151 by the radio network node 111 may be understood to be to detect the reflection of the first signal 151 from the one or more first objects 131 or the one or more second objects 132.

Determining may be understood as calculating, deriving or similar.

The determining in this Action 503 may be performed by inputting the obtained first information in Action 502 into the obtained function.

As stated earlier, the one or more characteristics may comprise: i) the time period during which, and ii) the frequency at which, the transmission to reception cancellation may be to be transmitted by the radio network node 111 to enable the detection of the one or more first objects 131 within the distance of the one or more second objects 132.

In some embodiments, the determining in this Action 503 may further comprise determining an angle of a beam used for the transmission.

Action 502 and Action 503 may be performed periodically, e.g., based on a diurnal cycle.

By determining the one or more characteristics of the first signal 151 to be transmitted by the radio network node 111 in this Action 503, the first node 101 may enable to improve utilization of communication and sensing since “muting” or halting of the communication in favor of sensing may take place only at critical times, thus enabling for maximum communication. Furthermore, the first node 101 may enable energy savings on the side of the radio network node 111 and any devices performing communication through the radio network node 111, since communication may be understood to not be halted naively, which may be understood to require retransmissions, but instead done diligently when there may be a need for it. Moreover, the first node 101 may enable to increase physical security without the need for additional hardware.

### Action 504

In this Action 504, the first node 101 provides an indication of the determined one or more characteristics, to the radio network node 111, or to the second node 102 operating in the communications system 100.

The indication provided in this Action 504 may be understood to be a second indication.

Providing may be understood as outputting, sending or transmitting.

The one or more characteristics indicated by the indication may comprise a transmission to reception cancellation.

In some embodiments, the indication may schedule the transmission of the first signal 151. In such embodiments, the indication may be sent to the radio network node 111, e.g., via the second link 162.

By the first node 101 providing the second indication to the radio network node 111 in this Action 504, the first node 101 may enable to estimate the collision of the one or more first objects 131 with the one or more second objects 132 without “muting” or halting of the communication naively. By the first node 101 providing the second indication to the second node 102, e.g., via the first link 161, in this Action 504, the first node 101 may enable the second node 102 to update the function and increase its level of accuracy.

### Action 505

In this Action 505, the first node 101 may obtain a third indication from the radio network node 111. The third indication may indicate second information indicating the presence of the one or more first objects 131 and the one or more second objects 132 in the space 150. The second information may be based on a transmission of the scheduled first signal 151 by the radio network node 111. In other words, the second information may be a consequence of the transmission of the scheduled first signal 151. The second information may comprise or indicate the reflection 152 that may have been obtained after transmitting the scheduled first signal 141. As explained earlier, the reflection 152 may have been detected by the radio network node 111 itself, as depicted in the non-limiting example of panel a) of FIG. 4, or by the other radio network nodes 112 and then indicated back to the radio network node 111, e.g., via the respective fifth link 165, as depicted in the non-limiting example of panel b) of FIG. 4. The second information may be as another observation of a state. Once a sweep with the transmitted first signal 151 may have been performed, the first node 101 may obtain the state again from the radio network node 111 as, e.g., s′.

Based on that and by performing different scans, the first node 101 may then measure distance over time or speed for a moving object.

In embodiments wherein the communications system 100 may comprise the plurality of radio network nodes 110, for the same reasons provided in Action 502, the obtaining of the third indication may be performed after the first network node 111 may have received the additional indication indicating that it may be clear to transmit the first signal 151, either because the first network node 111 may have been elected the leader, or because the leader may have concluded its transmission-to-reception cancellation window, and it may be the turn of the first network node 111 to perform the scanning.

This Action 505 may be performed in some of the embodiments wherein the indication may schedule the transmission of the first signal 151 and, the second indication may be sent to the radio network node 111.

By obtaining the third indication in this Action 505, the first node 101 may be enabled to determine a risk of collision of the one or more first objects 131 with the one or more second objects 132, as described in Action 506.

### Action 506

In this Action 506, the first node 101 may determine a risk of the collision based on the obtained third indication. The risk of the collision may be understood to be in the next x time steps. That is, the first node 101 may determine the risk of the collision of the one or more first objects 131 with the one or more second objects 132 using the second information indicating the presence of the one or more first objects 131 and the one or more second objects 132 in the space 150. This may be done, for example, by use of bounding boxes. Another other option may be via kd-trees, data structure, that may model the location of each object. Objects within objects in the kd-tree may be overlapping.

This Action 506 may be performed in some of the embodiments wherein the indication may schedule the transmission of the first signal 151 and, the second indication may be sent to the radio network node 111.

By determining the risk of the collision based on the obtained third indication in this Action 506, the first node 101, may then be enabled to perform an action based on the determined risk to avoid that the collision takes place, as described in the next Action 507.

### Action 507

In some embodiments, the first node 101 may, in this Action 507, send a fourth indication to the radio network node 111 or to the another node 103 operating in the communication system 100. The fourth indication may indicate the determined risk of collision.

The sending, e.g., transmitting, broadcasting, etc. . . . , of the fourth indication may be performed, e.g., via the first link 141 to the radio network node 111 and/or to the another node 103, e.g., via the third link 163. The another node 103 may be for example, a device able to produce an alarm sound.

The fourth indication may be, for example, a warning signal or alarm. The fourth indication may be a warning signal, in case where a potential collision may have been detected in Action 506.

The fourth indication may not be targeting the Radio Access Network (RAN) protocol only. In some examples of this Action 507, the fourth indication may be an application signal. The application signal may be sent by the first node 101 through the application layer to, for example, instruct the application controlling movement of the one or more second objects 132 to stop or slow down their movement. In another example, the application signal may indicate to replan the operation of the device so that it may avoid collision by sharing details of the potential collision which a robot for example may be able to utilize for that purpose.

The fourth indication may therefore be interpreted differently by the recipients. If the recipient is one of the one or more second objects 132, e.g., a robot, the second object 132 may stop or slow down its movement. If the recipient is one of the one or more first objects 131, e.g., a human, the human man react and change its course or position to avoid colliding with the object.

This Action 507 may be performed in some of the embodiments wherein the indication may schedule the transmission of the first signal 151 and, the second indication may be sent to the radio network node 111.

By sending the fourth indication in this Action 507, the first node 101 may enable to therefore avoid that the collision of the one or more first objects 131 with the one or more second objects 132 takes place by managing the behavior of the objects, by warning the humans involved, or by performing both. The first node 101 may therefore enable to enhance the security for humans, and the maintenance of the objects, e.g., robots in the space 150.

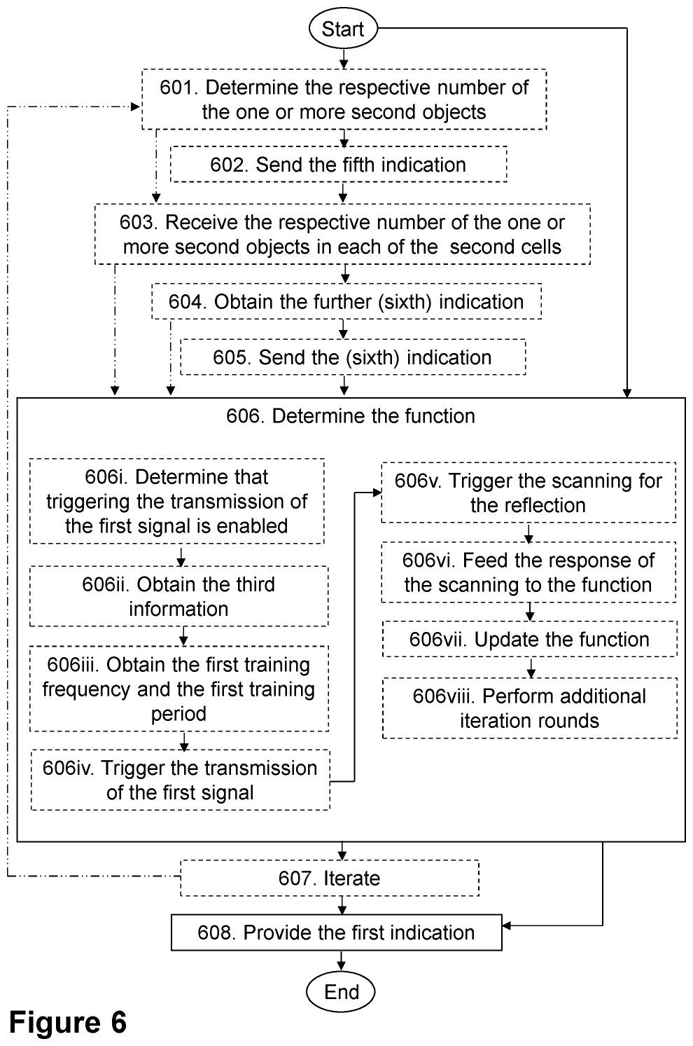

Embodiments of a computer-implemented method, performed by the second node 102, will now be described with reference to the flowchart depicted in FIG. 6. The method may be understood to be for handling transmission of the first signal 151. The second node 102 operates in the communications system 100.

The method may comprise the actions described below. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the second node 102 is depicted in FIG. 6. In FIG. 6, optional actions in some embodiments may be represented with dashed lines. The detailed description of some of the following corresponds to the same references provided above, in relation to the actions described for the first node 101 and will thus not be repeated here to simplify the description. For example, in some embodiments, at least one of the following options may apply. According to the first option, at least one of: a) the one or more first objects 131 and b) the one or more second objects 132 may be mobile. According to the second option, the one or more first objects 131 may consume broadband traffic and the one or more second objects 132 may consume machine-type of communication traffic, e.g., URLLC. According to the third option, the one or more first objects 131 may be human and the one or more second objects 132 may be robots.

### Action 601

The second node 102, as explained earlier may be understood to be the node in charge of training the function described earlier.

In embodiments, the radio network node 111 may be the first radio network node 111 of the plurality of radio network nodes 110 having overlapping radio coverage in the space 150 wherein the transmission of the first signal 151 may have to be produced. The first radio network node 111 may be serving one or more first cells 121 and each of the other radio network nodes 112 in the plurality of radio network nodes 110 may be serving, respectively, the one or more second cells 122.

In some of such embodiments, in this Action 601, the second node 102 may determine a respective number of objects, e.g., the one or more second objects 132, detected in each of the one or more first cells 121. This Action 601, as well as any of Actions 602-605, e.g., Actions 601, 603, 604 and 605, or Actions 601, 602 and 604, may be understood to be performed in other to ultimately elect a leader among the plurality of radio network nodes 110, for the reasons explained earlier, in the description of Action 502.

### Action 602

In this Action 602, the second node 102 may send a fifth indication, to at least one of the other radio network nodes 112 in the plurality of radio network nodes 110. The fifth indication may indicate the determined respective number of the one or more second objects 132.

This Action 602 may be performed in embodiments wherein a node different from the second node 102 may be in charge of determining who may be the leader. By performing this Action 602, the second node 102 may provide information to that node which may enable it to then determine which node may be the leader.

### Action 603

In this Action 603, the second node 102 may, optionally, receive, the respective number of the one or more second objects 132 detected in each of the one or more second cells 122 from each of the other radio network nodes 112 in the plurality of radio network nodes 110.

The receiving in this Action 603 may be performed e.g., via the respective fifth link 165.

### Action 604

In this Action 604, the second node 102 may obtain a further indication, which may be referred to herein as a sixth indication. The further indication may indicate which cell, out of the one or more first cells 121 and the one or more second cells 122 may have a larger number of objects, e.g., the one or more second objects 132. Transmission of the first signal 151 by any radio network node comprised in the plurality of radio network nodes 110 other than a radio network node controlling the indicated cell may have to be refrained until reception of the additional indication indicating transmission of the first signal 151 may be enabled. The additional indication may be referred to herein as a seventh indication. The indicated cell which may have the larger number of objects, e.g., the one or more second objects 132, may be understood to be elected as the leader.

Any of Actions 603, 604, may be performed in embodiments wherein the radio network node 111 may be the first radio network node 111 of the plurality of radio network nodes 110 having overlapping radio coverage in the space 150 wherein the transmission of the first signal 151 may have to be produced, and wherein the first radio network node 111 may be serving one or more first cells 121 and each of the other radio network nodes 112 in the plurality of radio network nodes 110 may be serving, respectively, the one or more second cells 122.

The obtaining of the further indication in this Action 604 may be performed, by the second node 102 performing the determination itself, gathering the information from the plurality of radio network nodes 110, or, by the second node 102 receiving the indication of who may have been elected the leader from another node. The obtaining in this Action 604 may also comprise retrieving the further indication from an internal memory, in the event the leader may have been previously elected and its identity stored.

### Action 605

In embodiments wherein the further indication obtained in Action 604 may be the sixth indication, the second node 102 may, in this Action 605, send the obtained sixth indication to the other radio network nodes 112 in the plurality of radio network nodes 110.

This Action 605 may be performed in embodiments wherein the second node 102 may have determined who the leader may be itself. By performing this Action 605, the second node 102 may then notify other nodes about the identity of the leader.

### Action 606

In this Action 606, the second node 102 determines the function, using machine learning. As described earlier, the function enables to determine the one or more characteristics of the first signal 151 to be transmitted by the radio network node 111 to enable the detection of the one or more first objects 131 within the distance of the one or more second objects 132 so that the collision of the one or more first objects 131 with the one or more second objects 132 is estimated. The transmission of the first signal 151 by the radio network node 111 is to detect the reflection 152 of the first signal 151 from the one or more first objects 131 or the one or more second objects 132.

The one or more characteristics may comprise: i) the time period during which, and ii) the frequency at which, the transmission to reception cancellation may be to be transmitted by the radio network node 111 to enable the detection of the one or more first objects 131 within the distance of the one or more second objects 132.

Determining may be understood as calculating, deriving, etc., The machine learning used may be a DQN.

In some embodiments, the determining in this Action 601 may be performed using reinforcement learning with one of: single agent reinforcement learning and multi agent reinforcement learning.

In some embodiments, the determining in this Action 601 may further comprise determining the angle of the beam used for the transmission.

The radio network node 111 may transmit the first signal 151 with the one or more antennas enabled to perform communication and sensing.

The determining in this Action 601 may be understood to comprise training the function. The training may comprise, in one iteration round, the following Actions 606i-606viii. In some embodiments, the iteration round may further comprise Actions 606ii-606viii. In particular embodiments, the iteration round may further comprise Action 606i.

In embodiments wherein the second node 102 may use a DQN, the second node 102 may initiate the DQN. The second node 102 may also initiate an experience buffer “B”, which may be used to train the DQN.

### Action 606i

In this Action 606i, the second node 102 may determine, based on the additional indication, that triggering 606iv the transmission of the first signal 151 by the radio network node 111 may be enabled. The iteration round may be performed with the proviso the additional, that is, the seventh, indication may have been obtained.

### Action 606ii

In this Action 606ii, the second node 102 may obtain third information indicating a presence of the one or more first objects 131 and the one or more second objects 132 in the space 150 wherein the transmission to reception cancellation may have to be produced.

The third information may indicate a state space comprising: static robots, moving robots, static humans and moving humans. The third information may, in one iteration round, indicate state “s”, of the state space described earlier. This Action 606ii may therefore comprise observing the state s by obtaining the third information from the radio network node 111. Here, it may be understood that the radio network node 111 may have transmitted the first signal 151, and received the reflection 152 of the first signal 151 from the one or more first objects 131 or the one or more second objects 132, as echoes resulting from the transmission. The reflection 152 may be processed to produce the state “s”.

### Action 606iii

In this Action 606iii, the second node 102 may obtain, using a heuristic search algorithm, a first set of the one or more characteristics. For example, the second node 102 may obtain a first training frequency, of a plurality of training frequencies, a first training period, of a plurality of training periods, and another indication indicating whether or not to pre-emptively puncture traffic during the first training period.

The first training frequency, the first training period, and the another indication for every iteration round may correspond to an action in an action space. In this Action 6060iii, the second node 102 may obtain an action “a” of the action space.

Following the non-limiting example provided earlier, the first training frequency, e.g., a radio frequency or carrier, may be one of three frequencies: f0, f1 and f2. The first training period may be one of three slots: Slot 0, Slot 1 and Slot 2, and the another indication may indicate one of indicating yes, and 1 indicating no.

The first training period may be understood as a set of time resources during which the first signal 151 may be transmitted during the training phase of the function, in one iteration round. If the another indication indicates that the traffic is to be pre-emptively punctured, the first training period may be understood to be a width of a Tx-To-Rx cancellation block.

The heuristic search algorithm may be a Monte Carlo Tree Search (MTSC). In such examples, an MCTS_tree may have been previously initialized. The heuristic search algorithm, which may be run by the second node 102, may have been switched to simulation mode, and may solve the potential effects that each action may have on the state observed in Action 606ii using the DQN and the different actions that may be performed. This may yield an action “a” from the action space previously described. In other words, the first set of the one or more characteristics may be obtained in this Action 606iii by the heuristic search algorithm solving the environment in the simulation mode.

### Action 606iv

The second node 102 may then perform the action “a” that may have been obtained from, or selected by, the heuristic search algorithm in Action 606iii, and schedule transmission of the first signal 151 using the obtained first set of the one or more characteristics.

In some embodiments, in this Action 606iv, the second node 102 may trigger transmission of the first signal 151 by the radio network node 111 with the first training frequency obtained in Action 606iii, while puncturing existing transmissions at the beginning of the first training period according to the another indication. By performing this Action 606iv, action may be expanded to the mini slot number, frequency and then to pre-empt or not, which may be scheduled to be performed by the radio network node 111.

### Action 606v

In this Action 606v, the second node 102 may trigger scanning, by the radio network node 111 or the second radio network node 112 operating in the communications system 100, for reception of the reflection 152 of the first signal 151 in response to the transmitted first signal 151 during the first training period. This Action 606v may be performed after t timesteps. This may be understood to be after the first signal 151 may have been submitted and echoes may have been received and processed. This Action 606v may be understood to correspond to the first node 101 observing the state again, which may now be referred to as s′.

The second node 102 may trigger the scanning by the first radio network node 111 in embodiments wherein the first radio network node 111 may be the only radio network node 111 covering the space 150, such as the example depicted in panel a) of FIG. 4. In embodiments wherein the second node 102 may use two different reference terminals, the first radio network node 111 to transmit the first signal 151, and a second reference terminal to receive the reflection 152 of the transmitted first signal 151, such as the example depicted in panel b) of FIG. 4, the second node 102 may trigger the scanning by the second radio network node 112.

### Action 606vi

In this Action 606vi, the second node 102 may feed a response of the scanning to the function. By feeding the response of the scanning to the function, the second node 102 may be enabled to calculate a reward function which may quantify how good the action taken may have been.

### Action 606vii

In this Action 606vii, the second node 102 may update the function with the fed response. The second node 102 may record the previous state, s, the new state, s′, and the action and the corresponding reward in the experience buffer “B”.

Action 606viii

In this Action 606viii, the second node 102 may perform additional iteration rounds until the function may achieve a desired performance level. By performing the additional iteration rounds, e.g., k iteration rounds, the second node 102 may train the DQN using input from the experience buffer B.

### Action 607

The leader radio network node among the plurality of radio network nodes 110 may be periodically elected, e.g., as the number of one or more first objects 131 and the number of one or more second objects 132 may change, e.g., due to their mobility.

In this Action 608, the second node 102 may iterate the determining 601 of the respective number and the obtaining 604 of the sixth indication, and optionally at least one of: a) the sending 602 of the fifth indication, and b) the receiving 603 of the respective number of the one or more second objects 132 detected in each of the one or more second cells 122 and the sending 605 of the obtained sixth indication.

Actions 601, 603, 604 and 605 may be performed in examples wherein the second node 102 may determine the leader itself. Actions 601, 602 and 604 may be performed in examples wherein another node may perform the election of the leader, and the obtaining of Action 604 may comprise receiving the sixth indication.

### Action 608

In this Action 608, the second node 102 may provide a first indication of the determined function to the first node 101 operating in the communications system 100.

The first indication may be, for example, a message comprising the determined function DQN (s,a).

By providing the first indication to the first node 101, the second node 102 may enable the first node 101 to then use the first indication during operation, in order to determine the one or more characteristics of the first signal 151 to be transmitted by the radio network node 111 in order to estimate and thereby avoid a collision of the one or more first objects 131 with the one or more second objects 132 while enabling maximum communication. This may be understood to be since communication may be understood to not be halted naively, but instead done diligently when there may be a need for it. Moreover, the second node 102 may enable to increase physical security without the need for additional hardware and enable energy savings on the radio network node 111 and any devices performing communication through the radio network node 111.

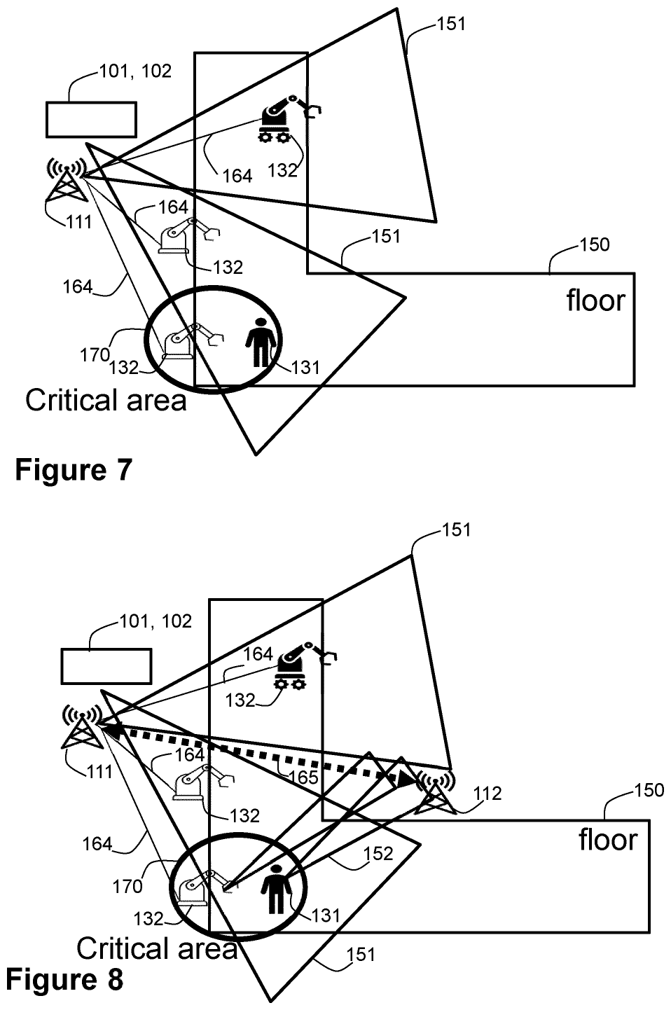

FIG. 7 is a schematic diagram depicting a further non-limiting example of a the communications system 100. The example of the communications system 100 depicted in FIG. 7 corresponds to the first variation of embodiments herein corresponding to a monostatic setup, wherein coordination between different radio network nodes may not be required. Instead, the first network node 111, e.g., a gNB, may broadcast the first signal 151 in two different cells, or with two different antennas. The first signal 151 may then produce a Tx-to-Rx cancellation block that may disrupt communication for a short period of time which may be used to detect the presence of different objects, that is, the one or more first objects 131, here a human, and the one or more second objects, here 2 static robotic arms, as solid white Figures, and one Automated Guided Vehicle (AGV), as a solid black figure. The space 150 here is the floor of a production plant. The first node 101 and the second node 102 are the same node, and they are separate from the first network node 111. The radio network node 111 communicates with the one or more second objects 132 via the respective fourth link 164.

FIG. 8 is a schematic diagram depicting another non-limiting example of a the communications system 100. The example of the communications system 100 depicted in FIG. 8 corresponds to the second variation of embodiments herein, wherein the communications system 100 may comprise a multi-static setup with the plurality of radio network nodes 110, e.g., multiple gNBs, where more antennas may be utilized for the same task. In such embodiments, there may be understood to be an additional challenge, that is, to make sure that neighboring cells covering the space 150 served by any of the radio network nodes in the plurality of radio network nodes 110, which cells may share the same bearing and may be scanning for objects in the same frequency, may not send a respective first signal 151, that is, a respective pulse, the initial part of a Tx-to-Rx cancellation block, when another radio network nodes may be doing so. This may be understood to be since, in that case, it may be possible that they may misinterpret that pulse as an echo, which may yield incorrect results. One other aspect to consider may be understood to be the number of critical objects, moving or not, and the number of moving noncritical objects, as cells that may have a high number of both may probably need to scan for potential collisions more often than others. Therefore, the different antennas may need to coordinate on how they may perform this scanning to avoid interfering with one another. The description of the elements depicted in FIG. 8 is otherwise the same as that provided in FIG. 7.

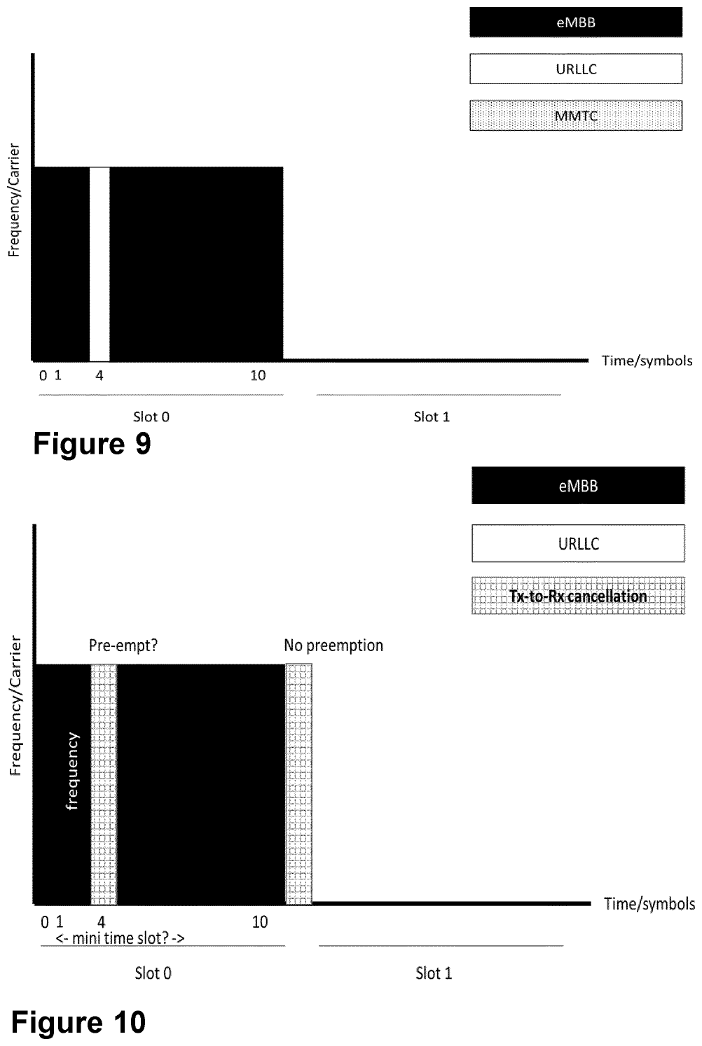

FIG. 9 is schematic diagram depicting a 2D representation of the different types of traffic in the communication system 100 due to the one or more first objects 131 and the one or more second objects 132. The x-axis represents the time domain and contains two types of transmission slots: slots and mini slots, while the y-axis represents the frequency domain. Particularly, FIG. 9 depicts the duration in symbols of two slots, Slot 0 and Slot 1. 0,1,4 and may be understood as identities of mini slots residing within slot 0. The traffic, illustrated as orthogonal boxes, may be of three different types: eMBB, URLLC and mMTC.

FIG. 10 is a schematic diagram depicting how a Packet Scheduler (PS) managed by the first node 111, or the radio network node 111, may schedule the Tx-to-Rx cancellation, which may or may now puncture traffic, e.g., eMBB. The goal of the first node 101 may be understood to be to determine when, e.g., which mini time slot, and how big, that is, which width, a Tx-to-Rx cancellation may need to be produced by the radio network node 111, in order to detect objects near robotic devices that may be potentially harmful. The description of the elements depicted in FIG. 10 is otherwise the same as that provided in FIG. 9.

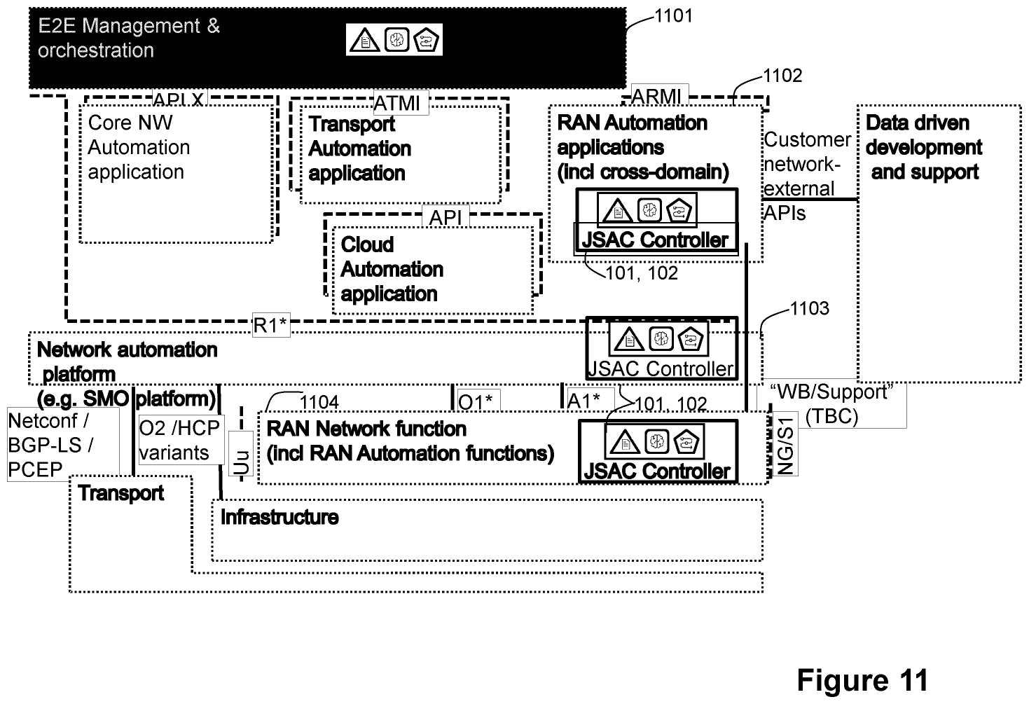

FIG. 11 is a schematic representation illustrating different positions in an automation architecture in the communications system 100, wherein any of the first node 101 and/or the second node 102, referred to as the first node 101/second node 102, and depicted as a JSAC Controller” may be placed, from higher layers to lower layers. Particularly, FIG. 11 shows how this application may work in an ORAN environment. In a first option, the first node 101/second node 102 may be placed in an End-to-end (E2E) application module 1101. Here, the first node 1101 JSAC may have more information across layers, so it may collect information from the end-application itself, core-User Plane Function (UPF) and 5G core, etc. In a second option, the first node 101/second node 102 may be placed in a RAN application module 1102, which may manage RAN Automation applications, including cross domain. Here, the first node 101/second node 102 may have more aggregated RAN level information, but not channel or sensing per slot level information. In a third option, the first node 101/second node 102 may be placed in a service management and orchestration platform 1103. In a fourth option, the first node 101/second node 102 may be placed in a RAN network function 1104. Here the first node 101/second node 102 may get more time granular level of sensing and channel information, maybe per transmission-slot level information. In a fifth option, the first node 101/second node 102 may be placed in a mixture of many of the above scenarios. The options for placing the first node 101/second node 102, in addition to the reasons above, may be understood to be the inherent properties of having a higher level controller versus a lower level controller. The higher level of the place of the first node 101/second node 102, wherein the highest may be understood to be the E2E APP, and the lowest may be understood to be the RAN NF, the more aggregated information may be gathered. The lower level of the place of the first node 101/second node 102, the more detailed information related to channel and retransmission, and sensing slot configurations may be made. Also depicted in FIG. 11 are: i) Customer network-external Application Programming Interfaces (APIs), e.g., Network Exposure Function (NEF)/Service Exposure Function (SEF), which may be used to expose the JSAC controller to customers, e.g., operators; ii) Data driven development and support, e.g., a development environment for simulation and testing of the RL agent, iii) Core NW Automation Application, as multiple applications may integrate with the JCAS controller; iv) Application Programming Interface (API) X, which may exist for the integration to take place; v) Automation Transport Management function (ATMI), the interface which may affect the routing of packets; vi) Transport Automation Application; vii) Automation Ran Management Interface (ARMI); viii) Cloud Automation Application/API, which may be used to orchestrate the deployment of different applications in a cloud environment; ix) R1 interface between rApps and Non-Real time Ran Intelligent Controller (RIC); x) Service Management and Orchestration (SMO) platform; xi) Netconf/Border Gateway Protocol Link-State (BGP-LS)/Path Computation Element Communication protocol (PCEP), SDN controllers; xii) O2/Hyperscale Provider (HCP) variants, wherein Ox may be understood to refer to the family of observation interfaces which may be used to monitor the state of the infrastructure; HCP may be understood as a reference to any other APIs that the Hyperscale, or cloud, provider may be exposing; xiii) Transport, which may be understood to refer to the transport infrastructure, e.g., set of routers; xiv) Infrastructure, which may be understood to refer to the HCP infrastructure provided by the cloud; xv) NG/S1, the interface between the RAN and Core networks; and xvi) WB/Support.

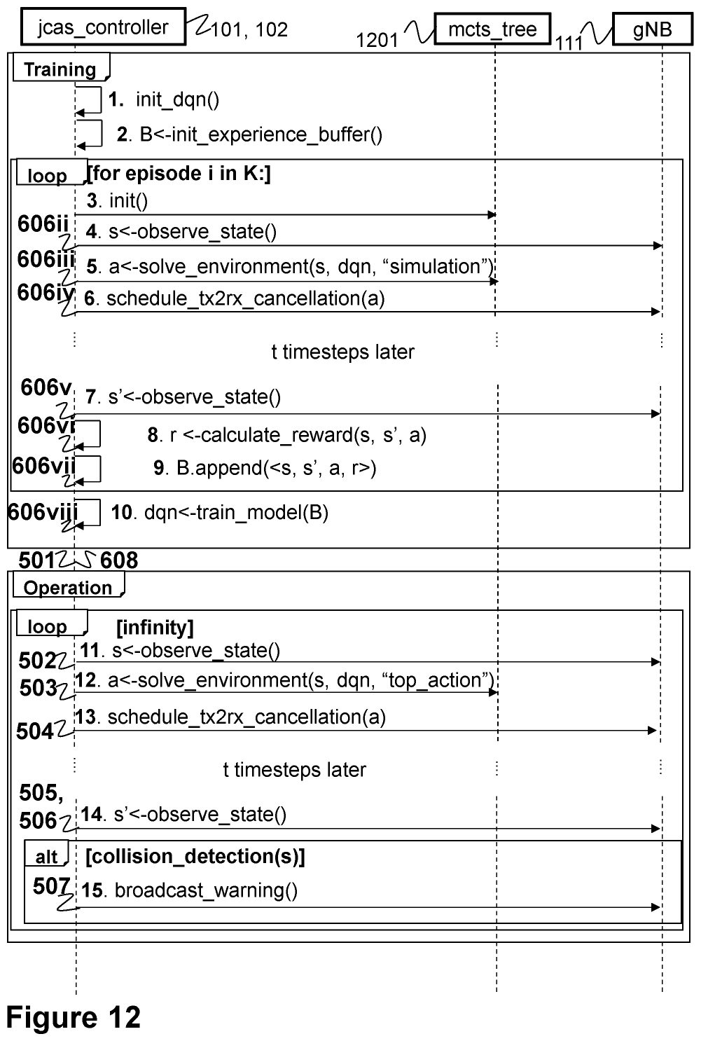

FIG. 12 is a signalling diagram illustrating a non-limiting example of a method performed by the second node 102, a JCAS controller, which in this example is the same node as the first node 101, according to embodiments herein. In step 1, the JCAS controller initiates its DQN, which is tasked to estimate the function Q(s,a). In step 2, the second node 102 initiates the experience buffer B which in this example may be used to train the DQN. Steps 3 to 8 correspond to the training phase of the function, and are performed in a loop, for every episode i in K. In Step 3, the MCTS_tree 1201 is initialized. In Step 4, in agreement with Action 606ii, the JCAS controller observes the state from the radio network node 111, here a gNB. Here it is assumed that the first signal 151, a pulse, has been transmitted (Tx) and over (Rx) the first radio network node 111 is now receiving echoes which are processed to produce the state that was collected previously. Based on this information, in Step 5, in agreement with Action 606iii, the JCAS controller asks the MCTS 1201 to switch to simulation mode and solve the potential effects that each action may have on this state using the DQN, and the different actions that may be performed. This yields an action a. In Step 6, in agreement with Action 606iv, the action is expanded to the mini slot number, frequency and width of the Tx-To-Rx cancellation block which may be scheduled to be performed by the gNB. After t timesteps, assuming that the pulse has been submitted and echoes have been received and processed, in Step 7, in agreement with Action 606v, the JCAS controller observes the state again, which is now s′. In Step 8, in agreement with Action 606vi, the JCAS controller calculates a reward function which quantifies how good this action was. In Step 9, in agreement with Action 606vii, the JCAS controller records this previous state, s, the new state s′ and the action and reward in the experience buffer B. In Step 10, in agreement with Action 606viii, the JCAS controller trains the DQN using input from B. Next, in agreement with Action 501 and Action 608, the second node 102 provide the first indication indicating the function to the first node 111. Steps 11-15 relate to the operation phase, which is the same as the training phase the MCTS no longer simulates different actions and the tree is not expanded, but instead, the first node 101 chooses the highest in step 12. The process starts in step 11, by, in according to Action 502, observing the current state. In Step 12, in agreement with Action 503, the first node 101 chooses action using the DQN and the MCTS but here, the first node 101 opts for the action that has the maximum q value. In Step 13, in agreement with Action 504, the first node 101 schedules the TX-to-RX cancellation. In Step 14, in agreement with Action 505 and 506, once a sweep has been performed, the first node 111 observes the state again. In Step 15, in agreement with Action 507, in the case where potential collision is detected, a warning signal is transmitted which may be interpreted differently by the recipients-if the recipient is a robot, it may stop or slow down its movement while if it is a human it may receive a warning.

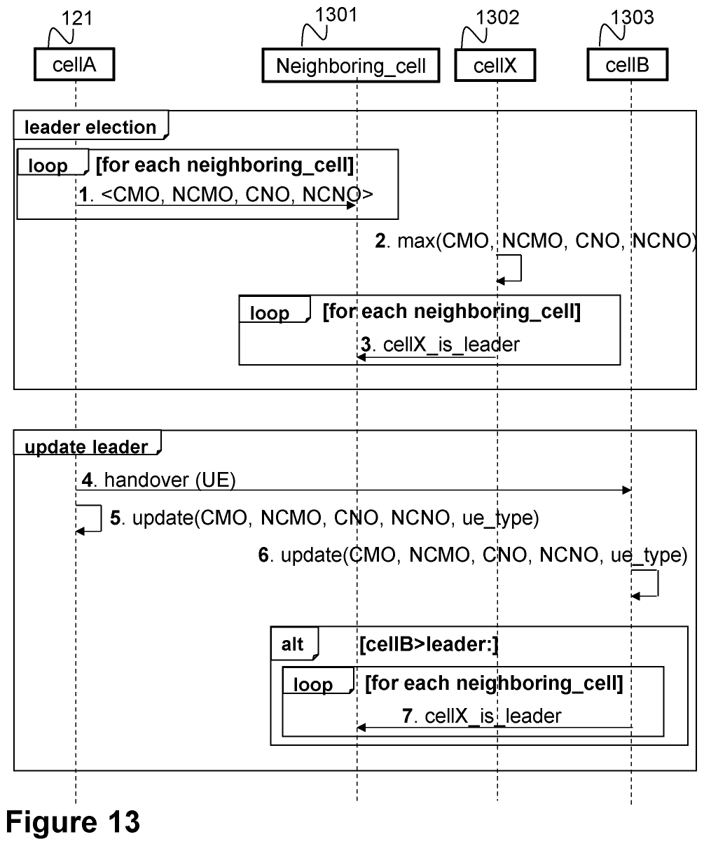

FIG. 13 is a signalling diagram illustrating a non-limiting example of a method performed in the communications system 100 for leader election in a multiple gNBs scenario, according to embodiments herein. One other aspect to consider is the number of critical objects, moving or not, and the number of moving noncritical objects, as cells that have a high number of both may probably need to scan for potential collisions more often than others. To enable orchestration and synchronization between neighboring cells, a round of leader election may be first performed between neighboring cells to determine the cell that has the most critical, moving or not, objects. In this non-limiting example, the first cell 121 is depicted as cell A. In step 1, in accordance with Action 602, the second node 102 broadcasts the fifth indication as a message indicating the determined respective number of the one or more second objects 132, which may comprise CMO, NCMO, CNO and NCNO. This may be done in a loop, for each neighboring cell 1301. This step of sending the fifth indication may only need to be performed once, at the cold-start case where the cells may have no information about each other. In Step 2, cell X 1302, which is this example is in charge of determining the leader, determines which cell comprise the highest number of objects, e.g., the maximum number of CMO, NCMO, CNO and NCNO. The elected leader is then indicated to each neighboring cell in a loop, as indicated in Step 3 for the neighboring cell 1301. The second node 102 may receive the sixth indication in accordance with Action 604. The leader election may be performed periodically. In step 4, a UE is handed over from cell A to cell B 1303. In Step 5, in agreement with Action 607, the second node 102 updates the respective number of the one or more second objects 132, which may comprise CMO, NCMO, CNO and NCNO and the UE type. In Step 6, the cell B 1303 does the same. In another alternative, cell B 1303 is in charge of determining the leader, who turns now to be cellX. Cell B 1303 may then in Step 7, indicate, in a loop for every neighboring cell, that cell X is now the leader. Once this loop is complete then the method depicted in FIG. 13 may apply in this case as well, but now the non-leading cells may be understood to have to wait for the leader to finish its scan before they may be enabled to scan.

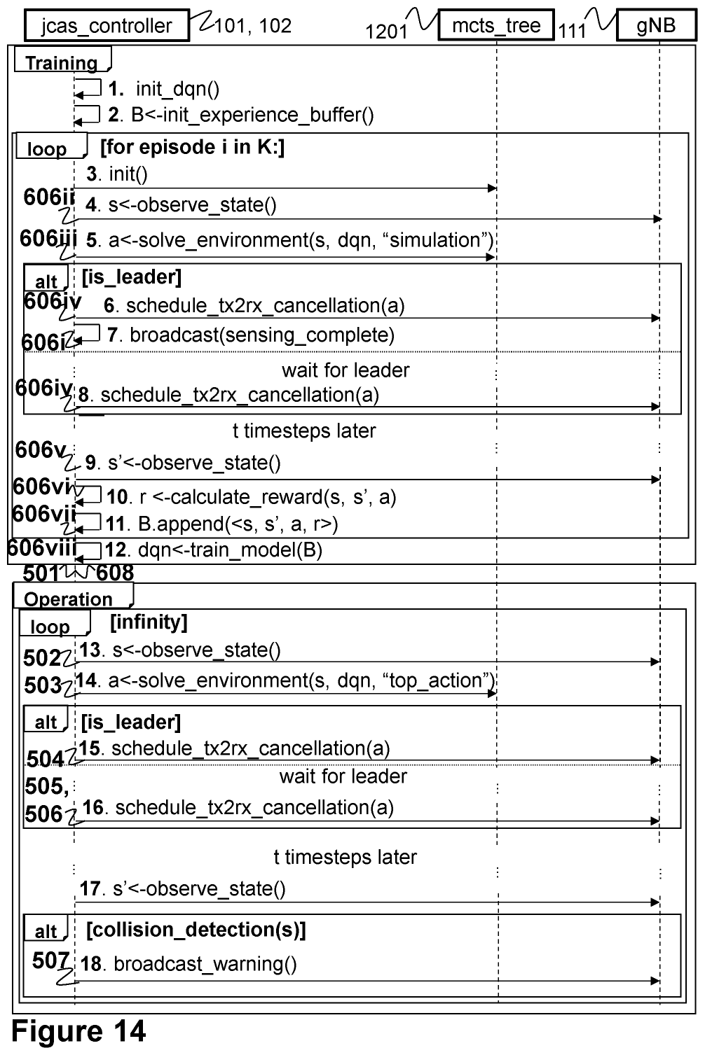

FIG. 14 is a signalling diagram illustrating a non-limiting example of a method performed by the second node 102, a JCAS controller, which in this example is the same node as the first node 101, according to embodiments herein, in a scenario wherein the communications system 100 may comprise the plurality of the radio network nodes 110. In the example of FIG. 14, Steps 1-5 are performed as described in FIG. 12. In a first alternative, the first node 101/second node 102 is the leader of the plurality of radio network nodes 110, and performs Step 6 as described for FIG. 12, and in Step 7, in agreement with Action 601i, then 102 broadcasts that the sensing is complete. Otherwise, if the first node 101/second node 102 is not the leader, it may need to wait until it receives the seventh indication, and then performs Step 8 as described in FIG. 12 for Step 6. Steps 9-14 are then performed as described in FIG. 12 for Steps 7-12. According to a first alternative, if the first node 101/second node 102 is the leader, it may perform Step 15 as described in FIG. 12 for Step 13. Otherwise, if the first node 101/second node 102 is not the leader, it may need to wait until it receives the seventh indication, and then performs Step 16 as described in FIG. 12 for Step 13. Steps 17-18 are then performed as described in FIG. 12 for Steps 14-15.

Certain embodiments disclosed herein may provide one or more of the following technical advantage(s), which may be summarized as follows. A first advantage, embodiments herein may be understood to enable an improved utilization of communication and sensing since “muting” or halting of the communication in favor of sensing may be learned to take place only at critical times thus allowing for maximum communication. A second advantage of embodiments herein may be understood to be energy savings on the side of the devices, e.g., UE, and/or radio network nodes, e.g., gNBs, since communication may be understood to not be halted naively, thus requiring retransmissions, but instead being performed diligently when there may be a need for it. Embodiments herein may further enable an increase in physical security via the proposed mechanism, as they may be understood to not require additional hardware.

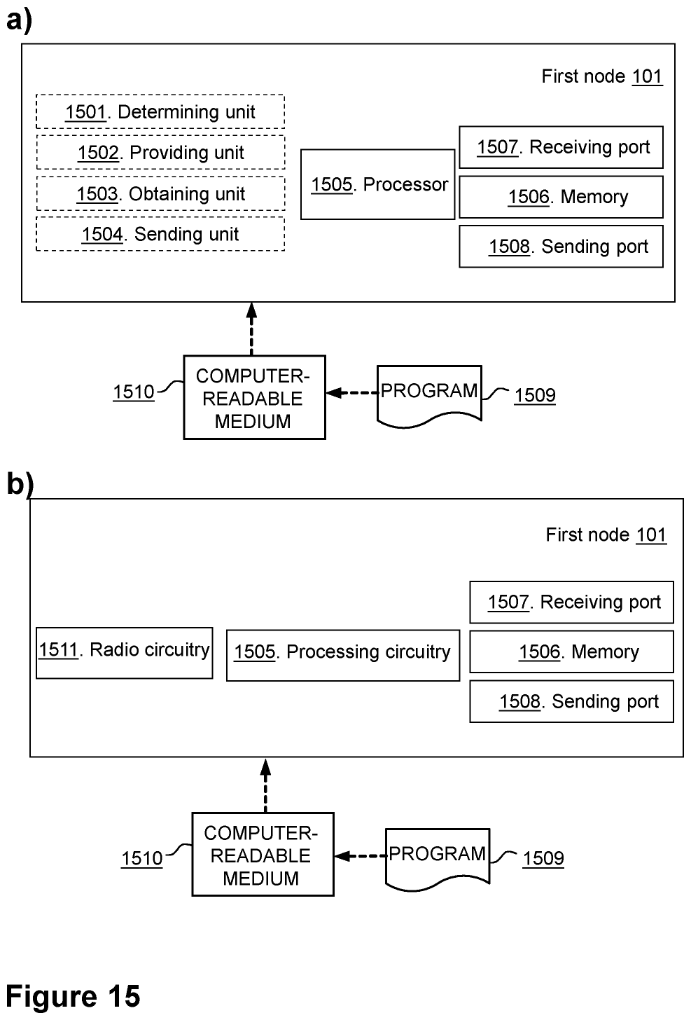

FIG. 15 depicts two different examples in panels a) and b), respectively, of the arrangement that the first node 101 may comprise to perform the method actions described above in relation to FIG. 5, FIGS. 7-8, FIG. 10 and/or FIGS. 12-14. In some embodiments, the first node 101 may comprise the following arrangement depicted in FIG. 15a. The first node 101 may be understood to be transmission of a first signal 151. The first node 101 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 15, optional boxes are indicated by dashed lines. The detailed description of some of the following corresponds to the same references provided above, in relation to the actions described for the first node 101 and will thus not be repeated here. For example, in some embodiments, at least one of the following options may apply. According to the first option, at least one of: a) the one or more first objects 131 and b) the one or more second objects 132 may be configured to be mobile. According to the second option, the one or more first objects 131 may be configured to consume broadband traffic and the one or more second objects 132 may be configured to consume machine-type of communication traffic, e.g., URLLC. According to the third option, the one or more first objects 131 may be human and the one or more second objects 132 may be configured to be robots.

The first node 101 is configured to, e.g. by means of a determining unit 1501 within the first node 101 configured to, determine the one or more characteristics of the first signal 151 to be transmitted by the radio network node 111 to enable the detection of the one or more first objects 131 within the distance of one or more second objects 132 so that the collision of the one or more first objects 131 with the one or more second objects 132 is estimated. The transmission of the first signal 151 by the radio network node 111 is configured to be to detect the reflection 152 of the first signal 151 from the one or more first objects 131 or the one or more second objects 132.

The first node 101 is also configured to, e.g. by means of a providing unit 1502 within the first node 101 configured to, provide the indication of the one or more characteristics configured to be determined, to the radio network node 111 or to a second node 102 configured to operate in the communications system 100.

In some embodiments, the indication may be configured to be the second indication and the first node 101 may be further configured to, e.g. by means of an obtaining unit 1503 within the first node 101 configured to, obtain the first indication from one of the memory and the second node 102. The first indication may be configured to indicate the function configured to be determined by the second node 102 using machine learning. The function may be configured to enable to determine the one or more characteristics, based on the first information configured to be input to the function. The first information may be configured to indicate the presence of the one or more first objects 131 and the one or more second objects 132 in the space 150 wherein the transmission of the first signal 151 may be configured to be produced.

In some embodiments wherein the indication may be configured to be the second indication, the first node 101 may be further configured to, e.g. by means of the obtaining unit 1503 configured to, obtain the first information to be input to the function. The determining may be configured to be performed by inputting the first information configured to be obtained into the function configured to be obtained.

In some embodiments, the determining may be further configured to comprise determining the angle of the beam configured to be used for the transmission.

In some embodiments, the indication may be configured to schedule the transmission of the first signal 151 and may be configured to be sent to the radio network node 111, and the first node 101 may be also configured to, e.g. by means of the obtaining unit 1502 within the first node 101 configured to, obtain the third indication from the radio network node 111. The third indication may be configured to indicate the second information. The second information may be configured to indicate the presence of the one or more first objects 131 and the one or more second objects 132 in the space 150. The second information may be configured to be based on the transmission by the radio network node 111 of the first signal 151 configured to be scheduled.

In some embodiments, wherein the indication may be configured to schedule the transmission of the first signal 151 and may be configured to be sent to the radio network node 111, the first node 101 may be further configured to, e.g. by means of the determining unit 1501 within the first node 101 configured to, determine the risk of the collision based on the third indication configured to be obtained.

In some embodiments, wherein the indication may be configured to schedule the transmission of the first signal 151 and may be configured to be sent to the radio network node 111, the first node 101 may be further configured to, e.g. by means of a sending unit 1504 within the first node 101 configured to, send the fourth indication to the radio network node 111 or to another node 103 configured to operate in the communication system 100. The fourth indication may be configured to indicate the risk of collision configured to be determined.

In some embodiments, the one or more characteristics may be configured to comprise: i) the time period during which, and ii) the frequency at which, the transmission to reception cancellation may be to be produced by the radio network node 111 to enable the detection of the one or more first objects 131 within the distance of the one or more second objects 132.

In some embodiments, the radio network node 111 may be configured to transmit the first signal 151 with the one or more antennas configured to enable to perform communication and sensing.

The embodiments herein may be implemented through one or more processors, such as a processor 1505 in the first node 101 depicted in FIG. 15, together with computer program code for performing the functions and actions of the embodiments herein. The program code mentioned above may also be provided as a computer program product, for instance in the form of a data carrier carrying computer program code for performing the embodiments herein when being loaded into the in the first node 101. One such carrier may be in the form of a CD ROM disc. It is however feasible with other data carriers such as a memory stick. The computer program code may furthermore be provided as pure program code on a server and downloaded to the first node 101.

The first node 101 may further comprise a memory 1506 comprising one or more memory units. The memory 1506 is arranged to be used to store obtained information, store data, configurations, schedulings, and applications etc. to perform the methods herein when being executed in the first node 101.

In some embodiments, the first node 101 may receive information from, e.g., the second node 102, the third node 103, the first radio network node 111, the second radio network node 112, the plurality of radio network nodes 110, any of the one or more first objects 131, any of the one or more second objects 132, and/or another node through a receiving port 1507. In some examples, the receiving port 1507 may be, for example, connected to one or more antennas in the first node 101. In other embodiments, the first node 101 may receive information from another structure in the communications system 100 through the receiving port 1507. Since the receiving port 1507 may be in communication with the processor 1505, the receiving port 1507 may then send the received information to the processor 1505. The receiving port 1507 may also be configured to receive other information.

The processor 1505 in the first node 101 may be further configured to transmit or send information to e.g., the second node 102, the third node 103, the first radio network node 111, the second radio network node 112, the plurality of radio network nodes 110, any of the one or more first objects 131, any of the one or more second objects 132, another node, and/or another structure in the communications system 100, through a sending port 1508, which may be in communication with the processor 1505, and the memory 1506.

Those skilled in the art will also appreciate that any of the units 1501-1504 described above may refer to a combination of analog and digital circuits, and/or one or more processors configured with software and/or firmware, e.g., stored in memory, that, when executed by the one or more processors such as the processor 1505, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1501-1504 described above may be the processor 1505 of the first node 101, or an application running on such processor.

Thus, the methods according to the embodiments described herein for the first node 101 may be respectively implemented by means of a computer program 1509 product, comprising instructions, i.e., software code portions, which, when executed on at least one processor 1505, cause the at least one processor 1505 to carry out the actions described herein, as performed by the first node 101. The computer program 1509 product may be stored on a computer-readable storage medium 1510. The computer-readable storage medium 1510, having stored thereon the computer program 1509, may comprise instructions which, when executed on at least one processor 1505, cause the at least one processor 1505 to carry out the actions described herein, as performed by the first node 101. In some embodiments, the computer-readable storage medium 1510 may be a non-transitory computer-readable storage medium, such as a CD ROM disc, a memory stick, or stored in the cloud space. In other embodiments, the computer program 1509 product may be stored on a carrier containing the computer program, wherein the carrier is one of an electronic signal, optical signal, radio signal, or the computer-readable storage medium 1510, as described above.

The first node 101 may comprise an interface unit to facilitate communications between the first node 101 and other nodes or devices, e.g., the second node 102, the third node 103, the first radio network node 111, the second radio network node 112, the plurality of radio network nodes 110, any of the one or more first objects 131, any of the one or more second objects 132, another node, and/or another structure in the communications system 100. In some particular examples, the interface may, for example, include a transceiver configured to transmit and receive radio signals over an air interface in accordance with a suitable standard.

In other embodiments, the first node 101 may comprise the following arrangement depicted in FIG. 15b. The first node 101 may comprise a processing circuitry 1505, e.g., one or more processors such as the processor 1505, in the first node 101 and the memory 1506. The first node 101 may also comprise a radio circuitry 1511, which may comprise e.g., the receiving port 1507 and the sending port 1508. The processing circuitry 1505 may be configured to, or operable to, perform the method actions according to FIG. 5, FIGS. 7-8, FIG. 10 and/or FIGS. 12-14, in a similar manner as that described in relation to FIG. 15a. The radio circuitry 1511 may be configured to set up and maintain at least a wireless connection with the second node 102, the third node 103, the first radio network node 111, the second radio network node 112, the plurality of radio network nodes 110, any of the one or more first objects 131, any of the one or more second objects 132, another node, and/or another structure in the communications system 100.

Hence, embodiments herein also relate to the first node 101 operative for handling data augmentation, the first node 101 being operative to operate in the communications system 100. The first node 101 may comprise the processing circuitry 1505 and the memory 1506, said memory 1506 containing instructions executable by said processing circuitry 1505, whereby the first node 101 is further operative to perform the actions described herein in relation to the first node 101, e.g., in FIG. 5, FIGS. 7-8, FIG. 10 and/or FIGS. 12-14.

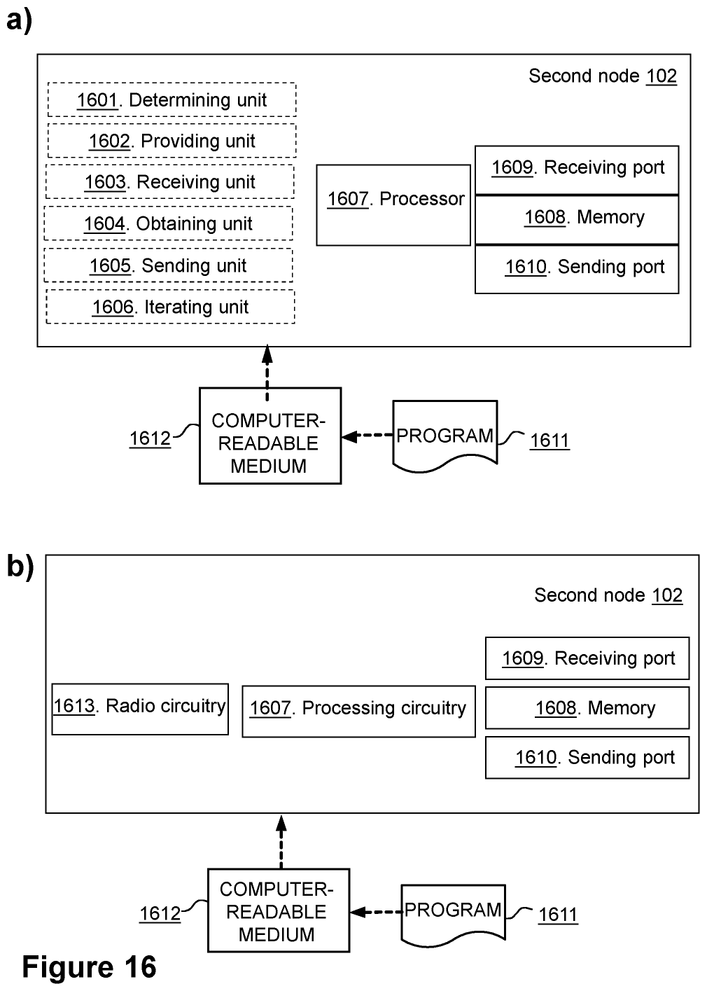

FIG. 16 depicts two different examples in panels a) and b), respectively, of the arrangement that the second node 102 may comprise to perform the method actions described above in relation to FIG. 6, FIGS. 7-8, FIG. 10 and/or FIGS. 12-14. In some embodiments, the second node 102 may comprise the following arrangement depicted in FIG. 16a. The second node 102 may be understood to be for handling transmission of the first signal 151. The second node 102 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 16, optional boxes are indicated by dashed lines. The detailed description of some of the following corresponds to the same references provided above, in relation to the actions described for the first node 101 and will thus not be repeated here. For example, in some embodiments, at least one of the following options may apply. According to the first option, at least one of: a) the one or more first objects 131 and b) the one or more second objects 132 may be configured to be mobile. According to the second option, the one or more first objects 131 may be configured to consume broadband traffic and the one or more second objects 132 may be configured to consume machine-type of communication traffic, e.g., URLLC. According to the third option, the one or more first objects 131 may be human and the one or more second objects 132 may be configured to be robots.

The second node 102 is configured to, e.g. by means of a determining unit 1601 within the second node 102 configured to, determine the function, using machine learning, wherein the function is configured to enable to determine the one or more characteristics of the first signal 151. The signal 151 is configured to be transmitted by the radio network node 111 to enable detection of the one or more first objects 131 within the distance of the one or more second objects 132 so that the collision of the one or more first objects 131 with the one or more second objects 132 is estimated. The transmission of the first signal 151 by the radio network node 111 is to detect the reflection 152 of the first signal 151 from the one or more first objects 131 or the one or more second objects 132.

The second node 102 is also configured to, e.g. by means of a providing unit 1602 within the second node 102 configured to, provide the first indication of the function configured to be determined to the first node 101 configured to operate in the communications system 100.

In some embodiments, the determining may be configured to be performed using reinforcement learning with one of: single agent reinforcement learning and multi agent reinforcement learning.

In some embodiments, the determining may be further configured to comprise determining the angle of the beam used for the transmission.

In some embodiments, the determining may be configured to comprise training the function, and the training may be configured to comprise, in one iteration round, obtaining the third information configured to indicate the presence of the one or more first objects 131 and the one or more second objects 132 in the space 150 wherein the transmission to reception cancellation is to be produced.

In some embodiments, wherein the determining may be configured to comprise training the function, and the training may be configured to comprise, in one iteration round, obtaining, using the heuristic search algorithm, the first training frequency, of the plurality of training frequencies the a first training period, of the plurality of training periods, and the another indication configured to indicate whether or not to pre-emptively puncture traffic during the first training period.

In some embodiments, wherein the determining may be configured to comprise training the function, and the training may be configured to comprise, in one iteration round, triggering transmission of the first signal 151 by the radio network node 111 with the first training frequency, while puncturing existing transmissions at the beginning of the first training period according to the another indication.

In some embodiments, wherein the determining may be configured to comprise training the function, and the training may be configured to comprise, in one iteration round, triggering scanning, by the radio network node 111 or the second radio network node 112 configured to operate in the communications system 100, for reception of the reflection 152 of the first signal 151 in response to the first signal 151 configured to be transmitted during the first training period.

In some embodiments, wherein the determining may be configured to comprise training the function, and the training may be configured to comprise, in one iteration round, feeding the response of the scanning to the function.

In some embodiments, wherein the determining may be configured to comprise training the function, and the training may be configured to comprise, in one iteration round, updating the function with the fed response.

In some embodiments, wherein the determining may be configured to comprise training the function, and the training may be configured to comprise, in one iteration round, performing additional iteration rounds until the function achieves the desired performance level.

In some embodiments, at least one of the following options may apply. According to a first option, the third information may indicate the state space comprising: static robots, moving robots, static humans and moving humans. According to a second option, the first training frequency, the first training period, and the another indication for every iteration round may be configured to correspond to the action in the action space.

In a group of embodiments, the radio network node 111 may be configured to be the first radio network node 111 of the plurality of radio network nodes 110 configured to have overlapping radio coverage in the space 150 wherein the transmission of the first signal 151 may be to be produced. The first radio network node 111 may be configured to serve the one or more first cells 121 and each of the other radio network nodes 112 in the plurality of radio network nodes 110 may be configured to serve, respectively, the one or more second cells 122.

In some of the embodiments in the group of embodiments, the second node 102 may be further configured to, e.g. by means of the determining unit 1601 within the second node 102 configured to, determine the respective number of the one or more second objects 132 configured to be detected in each of the one or more first cells 121.

In some of the embodiments in the group of embodiments, the second node 102 may be further configured to, e.g. by means of a receiving unit 1603 within the second node 102 configured to, optionally, receive, the respective number of the one or more second objects 132 configured to be detected in each of the one or more second cells 122 from each of the other radio network nodes 112 in the plurality of radio network nodes 110.

In some of the embodiments in the group of embodiments, the second node 102 may be further configured to, e.g. by means of an obtaining unit 1604 within the second node 102 configured to, obtain the further indication. The further indication may be configured to indicate which cell, out of the one or more first cells 121 and the one or more second cells 122 may be configured to have the larger number of the one or more second objects 132. The transmission of the first signal 151 by any radio network node configured to be comprised in the plurality of radio network nodes 110 other than the radio network node configured to be controlling the cell configured to be indicated may be to be refrained until reception of the additional indication configured to indicate transmission of the first signal 151 may be enabled.

In some embodiments, the iteration round may be further configured to comprise, e.g. by means of the determining unit 1601 within the second node 102 configured to, determining, based on the additional indication, that triggering the transmission of the first signal 151 by the radio network node 111 may be enabled, and the iteration round may be configured to be performed with the proviso the additional indication may be configured to be obtained.

In some embodiments, the further indication may be configured to be the sixth indication, and the second node 102 may be configured to at least one of the following three options.

According to a first option, the second node 102 may be configured to, e.g. by means of a sending unit 1605 within the second node 102 configured to, send the fifth indication to at least one of the other radio network nodes 112 in the plurality of radio network nodes 110. The fifth indication may be configured to indicate the respective number of the one or more second objects 132 configured to be determined.

According to a second option, the second node 102 may be configured to, e.g. by means of the sending unit 1605 within the second node 102 configured to, send the sixth indication configured to be obtained to the other radio network nodes 112 in the plurality of radio network nodes 110.

According to a third option, the second node 102 may be configured to, e.g. by means of an iterating unit 1606 within the second node 102 configured to, iterate the determining of the respective number and the obtaining of the sixth indication, and optionally at least one of: a) the sending of the fifth indication and b) the receiving of the respective number of the one or more second objects 132 detected in each of the one or more second cells 122 and the sending of the sixth indication configured to be obtained.

In some embodiments, the one or more characteristics may be configured to comprise: i) the time period during which, and ii) the frequency at which, the transmission to reception cancellation may be to be produced by the radio network node 111 to enable the detection of the one or more first objects 131 within the distance of the one or more second objects 132.

In some embodiments, the radio network node 111 may be configured to transmit the first signal 151 with the one or more antennas configured to enable to perform communication and sensing.

The embodiments herein may be implemented through one or more processors, such as a processor 1607 in the second node 102 depicted in FIG. 16, together with computer program code for performing the functions and actions of the embodiments herein. The program code mentioned above may also be provided as a computer program product, for instance in the form of a data carrier carrying computer program code for performing the embodiments herein when being loaded into the in the second node 102. One such carrier may be in the form of a CD ROM disc. It is however feasible with other data carriers such as a memory stick. The computer program code may furthermore be provided as pure program code on a server and downloaded to the second node 102.

The second node 102 may further comprise a memory 1608 comprising one or more memory units. The memory 1608 is arranged to be used to store obtained information, store data, configurations, schedulings, and applications etc. to perform the methods herein when being executed in the second node 102.

In some embodiments, the second node 102 may receive information from, e.g., the first node 101, the third node 103, the first radio network node 111, the second radio network node 112, the plurality of radio network nodes 110, any of the one or more first objects 131, any of the one or more second objects 132, and/or another node, through a receiving port 1609. In some examples, the receiving port 1609 may be, for example, connected to one or more antennas in the second node 102. In other embodiments, the second node 102 may receive information from another structure in the communications system 100 through the receiving port 1609. Since the receiving port 1609 may be in communication with the processor 1607, the receiving port 1609 may then send the received information to the processor 1607. The receiving port 1609 may also be configured to receive other information.

The processor 1607 in the second node 102 may be further configured to transmit or send information to e.g., the first node 101, the third node 103, the first radio network node 111, the second radio network node 112, the plurality of radio network nodes 110, any of the one or more first objects 131, any of the one or more second objects 132, another node, and/or another structure in the communications system 100, through a sending port 1610, which may be in communication with the processor 1607, and the memory 1608.

Those skilled in the art will also appreciate that the units 1601-1606 described above may refer to a combination of analog and digital circuits, and/or one or more processors configured with software and/or firmware, e.g., stored in memory, that, when executed by the one or more processors such as the processor 1607, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The units 1601-1606 described above may be the processor 1607 of the second node 102, or an application running on such processor.

Thus, the methods according to the embodiments described herein for the second node 102 may be respectively implemented by means of a computer program 1611 product, comprising instructions, i.e., software code portions, which, when executed on at least one processor 1607, cause the at least one processor 1607 to carry out the actions described herein, as performed by the second node 102. The computer program 1611 product may be stored on a computer-readable storage medium 1612. The computer-readable storage medium 1612, having stored thereon the computer program 1611, may comprise instructions which, when executed on at least one processor 1607, cause the at least one processor 1607 to carry out the actions described herein, as performed by the second node 102. In some embodiments, the computer-readable storage medium 1612 may be a non-transitory computer-readable storage medium, such as a CD ROM disc, a memory stick, or stored in the cloud space. In other embodiments, the computer program 1611 product may be stored on a carrier containing the computer program, wherein the carrier is one of an electronic signal, optical signal, radio signal, or the computer-readable storage medium 1612, as described above.

The second node 102 may comprise an interface unit to facilitate communications between the second node 102 and other nodes or devices, e.g., the first node 101, the third node 103, the first radio network node 111, the second radio network node 112, the plurality of radio network nodes 110, any of the one or more first objects 131, any of the one or more second objects 132, another node, and/or another structure in the communications system 100. In some particular examples, the interface may, for example, include a transceiver configured to transmit and receive radio signals over an air interface in accordance with a suitable standard.

In other embodiments, the second node 102 may comprise the following arrangement depicted in FIG. 16b. The second node 102 may comprise a processing circuitry 1607, e.g., one or more processors such as the processor 1607, in the second node 102 and the memory 1608. The second node 102 may also comprise a radio circuitry 1613, which may comprise e.g., the receiving port 1609 and the sending port 1610. The processing circuitry 1607 may be configured to, or operable to, perform the method actions according to FIG. 6, FIGS. 7-8, FIG. 10 and/or FIGS. 12-14, in a similar manner as that described in relation to FIG. 16a. The radio circuitry 1613 may be configured to set up and maintain at least a wireless connection with the first node 101, the third node 103, the first radio network node 111, the second radio network node 112, the plurality of radio network nodes 110, any of the one or more first objects 131, any of the one or more second objects 132, another node, and/or another structure in the communications system 100.

Hence, embodiments herein also relate to the second node 102 operative for handling transmission of the first signal 151, the second node 102 being operative to operate in the communications system 100. The second node 102 may comprise the processing circuitry 1607 and the memory 1608, said memory 1608 containing instructions executable by said processing circuitry 1607, whereby the second node 102 is further operative to perform the actions described herein in relation to the second node 102, e.g., in FIG. 6, FIGS. 7-8, FIG. 10 and/or FIGS. 12-14.

When using the word “comprise” or “comprising”, it shall be interpreted as non-limiting, i.e. meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. Guez et. al—Learning Search with MCTSnets—https://arxiv.org/abs/1802.04697

1. A computer-implemented method, performed by a first node, the method being for handling transmission of a first signal, the first node operating in a communications system, the method comprising:
determining one or more characteristics of the first signal to be transmitted by a radio network node to enable detection of one or more first objects within a distance of one or more second objects so that a collision of the one or more first objects with the one or more second objects is estimated, wherein the transmission of the first signal by the radio network node is to detect a reflection of the first signal from the one or more first objects or the one or more second objects, and
providing an indication of the determined one or more characteristics to the radio network node or to a second node operating in the communications system.

2. The method according to claim 1, wherein the indication is a second indication and wherein the method further comprises:
obtaining a first indication from one of a memory and the second node, the first indication indicating a function determined by the second node using machine learning, wherein the function enables to determine the one or more characteristics, based on first information input to the function, the first information indicating a presence of the one or more first objects and the one or more second objects in a space wherein the transmission of the first signal is to be produced, and
obtaining the first information to be input to the function, and wherein the determining is performed by inputting the obtained first information into the obtained function.

3. The method according to claim 1, wherein the determining further comprises determining an angle of a beam used for the transmission.

4. The method according to claim 1, wherein the indication schedules the transmission of the first signal and is sent to the radio network node, and wherein the method further comprises:
obtaining a third indication from the radio network node, the third indication indicating second information indicating the presence of the one or more first objects and the one or more second objects in the space, the second information being based on a transmission of the scheduled first signal by the radio network node,
determining a risk of the collision based on the obtained third indication, and
sending a fourth indication to the radio network node or to another node operating in the communication system, the fourth indication indicating the determined risk of collision.

5. The method according to claim 1, wherein the one or more characteristics comprise: i) a time period during which, and ii) a frequency at which, a transmission to reception cancellation is to be produced by the radio network node to enable the detection of the one or more first objects within the distance of the one or more second objects.

6. The method according claim 1, wherein the radio network node transmits the first signal with one or more antennas enabled to perform communication and sensing.

7. The method according to claim 1, wherein at least one of:
i. at least one of: a) the one or more first objects and b) the one or more second objects are mobile,
ii. the one or more first objects consume broadband traffic and the one or more second objects consume machine-type of communication traffic, and
iii. the one or more first objects are human and the one or more second objects are robots.

8. A computer-implemented method, performed by a second node, the method being for handling transmission of a first signal, the second node operating in a communications system, the method comprising:
determining a function, using machine learning, wherein the function enables to determine one or more characteristics of the first signal to be transmitted by a radio network node to enable detection of one or more first objects within a distance of one or more second objects so that a collision of the one or more first objects with the one or more second objects is estimated, wherein the transmission of the first signal by the radio network node is to detect a reflection of the first signal from the one or more first objects or the one or more second objects, and
providing a first indication of the determined function to a first node operating in the communications system.

9. The method according to claim 8, wherein the determining is performed using reinforcement learning with one of: single agent reinforcement learning and multi agent reinforcement learning.

10. The method according to claim 8, wherein the determining further comprises determining an angle of a beam used for the transmission.

11. The method according to claim 8, wherein the determining comprises training the function, wherein the training comprises, in one iteration round:
obtaining third information indicating a presence of the one or more first objects and the one or more second objects in a space wherein the transmission to reception cancellation is to be produced,
obtaining, using a heuristic search algorithm, a first training frequency, of a plurality of training frequencies, a first training period, of a plurality of training periods, and another indication indicating whether or not to pre-emptively puncture traffic during the first training period,
triggering transmission of the first signal by the radio network node with the first training frequency, while puncturing existing transmissions at the beginning of the first training period according to the another indication,
triggering scanning, by the radio network node or a second radio network node operating in the communications system, for reception of the reflection of the first signal in response to the transmitted first signal during the first training period,
feeding a response of the scanning to the function, and
updating the function with the fed response, and
performing additional iteration rounds until the function achieves a desired performance level.

12. The method according to claim 11, wherein at least one of:
a. the third information indicates a state space comprising: static robots, moving robots, static humans and moving humans, and
b. the first training frequency, the first training period, and the another indication for every iteration round correspond to an action in an action space.

13. The method according to claim 8, wherein the radio network node is a first radio network node of a plurality of radio network nodes having overlapping radio coverage in a space wherein the transmission of the first signal is to be produced, the first radio network node serving one or more first cells and each of the other radio network nodes in the plurality of radio network nodes serving, respectively, one or more second cells, and wherein the method further comprises:
determining a respective number of the one or more second objects detected in each of the one or more first cells,
optionally, receiving, the respective number of the one or more second objects detected in each of the one or more second cells from each of the other radio network nodes in the plurality of radio network nodes, and
obtaining a further indication, the further indication indicating which cell, out of the one or more first cells and the one or more second cells has a larger number of the one or more second objects, wherein transmission of the first signal by any radio network node comprised in the plurality of radio network nodes other than a radio network node controlling the indicated cell is to be refrained until reception of an additional indication indicating transmission of the first signal is enabled.

14.-15. (canceled)

16. The method according to claim 8, wherein the one or more characteristics comprise: i) a time period during which, and ii) a frequency at which, a transmission to reception cancellation is to be produced by the radio network node to enable the detection of the one or more first objects within the distance of the one or more second objects.

17. The method according to claim 8, wherein the radio network node transmits the first signal with one or more antennas enabled to perform communication and sensing.

18. The method according to claim 8, wherein at least one of:
i. at least one of: a) the one or more first objects and b) the one or more second objects are mobile,
ii. the one or more first objects consume broadband traffic and the one or more second objects consume machine-type of communication traffic, and
iii. the one or more first objects are human and the one or more second objects are robots.

19. A first node, for handling transmission of a first signal, the first node being configured to operate in a communications system, the first node being further configured to:
determine one or more characteristics of the first signal to be transmitted by a radio network node to enable detection of one or more first objects within a distance of one or more second objects so that a collision of the one or more first objects with the one or more second objects is estimated, wherein the transmission of the first signal by the radio network node is configured to be to detect a reflection of the first signal from the one or more first objects or the one or more second objects, and
provide an indication of the one or more characteristics configured to be determined, to the radio network node or to a second node configured to operate in the communications system.

20.-25. (canceled)

26. A second node, for handling transmission of a first signal, the second node being configured to operate in a communications system, the second node being further configured to:
determine a function, using machine learning, wherein the function is configured to enable to determine one or more characteristics of the first signal configured to be transmitted by a radio network node to enable detection of one or more first objects within a distance of one or more second objects so that a collision of the one or more first objects with the one or more second objects is estimated, wherein the transmission of the first signal by the radio network node is to detect a reflection of the first signal from the one or more first objects or the one or more second objects, and
provide a first indication of the function configured to be determined to a first node configured to operate in the communications system.

27.-37. (canceled)

38. A computer program product comprising a non-transitory computer-readable storage medium, having stored thereon a computer program, comprising instructions which, when executed on processing circuitry, cause the processing circuitry to carry out the method according to claim 1.

39. (canceled)

40. A computer program product comprising a non-transitory computer-readable storage medium, having stored thereon a computer program, comprising instructions which, when executed on processing circuitry, cause the processing circuitry to carry out the method according to claim 8.
